(19) United States
(12) Patent Application Publication
(10) Pub. No.: US 2024/0376236 A1
(43) Pub. Date: Nov. 14, 2024

(54) BIMODAL POLY(ETHYLENE-CO-1-ALKENE) COPOLYMER AND BLOW-MOLDED INTERMEDIATE BULK CONTAINERS MADE THEREFROM

(71) Applicant: Univation Technologies, LLC, Houston, TX (US)

(72) Inventors: Elva L. Lugo, Lake Jackson, TX (US); Chuan C. He, Missouri City, TX (US); Hyunwoo Kim, Manvel, TX (US); David W. Kababik, Whitehouse, NJ (US); John F. Szul, Hurricane, WV (US); Mridula Kapur, Lake Jackson, TX (US)

(21) Appl. No.: 18/292,493

(22) PCT Filed: Oct. 18, 2022
(86) PCT No.: PCT/US2022/046982

§ 371 Date: Jan. 26, 2024

Related U.S. Application Data
(60) Provisional application No. 63/270,319, filed on Oct. 21, 2021.

(51) Int. Cl. C08F 210/16; C08F 2/34; C08F 4/64; C08F 4/659; C08F 4/6592

(52) U.S. Cl. CPC C08F 210/16; C08F 2/34; C08F 4/64148; C08F 4/65912; C08F 4/65916; C08F 4/65925; C08F 2800/20

(57) ABSTRACT

A bimodal poly(ethylene-co-1-alkene) copolymer comprising a higher molecular weight poly(ethylene-co-1-alkene) copolymer component and a lower molecular weight poly(ethylene-co-1-alkene) copolymer component. The copolymer is characterized by a unique combination of features comprising, or reflected in, its component weight fraction amount, density, high load melt index, molecular weight distributions, viscoelastic properties, environmental stress-cracking resistance, and impact strength. Additional inventive embodiments include a method of making the copolymer, a formulation comprising the copolymer and at least one additive that is different than the copolymer, a method of making a manufactured article from the copolymer or formulation; the manufactured article made thereby, and use of the manufactured article.

### FIELD

Bimodal poly(ethylene-co-1-alkene) copolymer and related methods and articles.

### INTRODUCTION

Patent application publications and patents in or about the field include CA2951113A, EP3116922A1, EP3116923A1, EP3347187A1, U.S. Pat. Nos. 7,432,328B2, 7,858,702B2, 7,868,092B2, 8,202,940B2, 8,383,730B2, 9,169,337B2, 9,273,170B2, 9,475,898B2, 9,493,589B1, 9,714,305B2, 9,963,528B2, US20150065669A1, US20200048384A1, WO2014043364A1, WO2018147968A1, WO2020028059A1, WO2020068413A1, WO2020223191A1, WO2020223193A1, and WO2021021473A1.

US 2015/0065669 A1 seeks a polymerization process for the production of olefin polymers. (Abstract) and higher density polyolefins with improved stress crack resistance (Title and Abstract). In an aspect the olefin polymer (e.g., an ethylene copolymer) consistent with this can be characterized as having a density from about 0.930 to about 0.948 g/cm³, a zero-shear viscosity greater than about 5×10⁵ Pa-sec, a CY-a parameter in the range from about 0.01 to about 0.40, a peak molecular weight in a range from about 30,000 to about 130,000 g/mol, and a reverse comonomer distribution ([0006]). Other olefin polymers are mentioned ([0006]). Zero shear viscosity is taught as being an indicator of melt strength (paragraph [0283]).

U.S. Pat. No. 9,273,170 B2 seeks polymers with improved toughness and ESCR for large-part blow molding performance (Title). In an aspect, ethylene polymers described therein can have a ratio of Mz/Mw in a range from about 3.5 to about 8.5 (column 39, lines 36-37). Zero shear viscosity is taught as being an indicator of melt strength (column 48, line 62).

WO 2020/223191 A1 seeks a bimodal poly(ethylene-co-1-alkene) copolymer (title) for large-part blow molded (LPBM) articles such as drums (paragraph [0007]). These drums should have good top-load performance such that when filled they should be stackable without external support structure. To capture this top-load performance, density is 0.950 to 0.957 g/cm³.

### SUMMARY

We have observed that industry standards for large containers (e.g., drums or intermediate bulk containers (IBCs)) composed of polyethylene resins require robust end-use performance, including top load (stiffness), toughness, impact strength, and environmental stress crack resistance (ESCR). The containers are manufactured by a large-part blow-molding (LPBM) process, the satisfactory performance of which requires the resins to have good processability, melt strength, and parison thickness and diameter swell. The properties required for end-use performance and those required for manufacturability compete with each other. On one hand, improving a resin's properties to enhance its manufacturability can weaken the end-use performance of the resulting containers. On the other hand, improving the resin's properties to enhance the containers' end-use performance can deteriorate the resin's LPBM process performance. To avoid a situation where either the industry standards for containers are not met, the containers cannot be manufactured, or both, a polyethylene resin grade for containers must have a proper balance of these competing properties.

We have recognized that improving performance of containers while achieving this balance of competing properties is challenging and not predictable ahead of time due to unknowable variables. Such unknowable variables include different polymerization catalysts inherently produce different resins with different combinations of properties, different gas phase polymerization process conditions inherently produce different combinations of resin properties, and different fundamental types of polyethylene resins (e.g., unimodal versus bimodal, higher density versus lower density) inherently produce different combinations of properties. For example, bimodal polyethylene compositions include a higher molecular weight polyethylene component (HMW component) and a lower molecular weight polyethylene component (LMW component) with more 1-alkene comonomeric content (e.g., 1-hexenic content) in the HMW component than in the LMW component, or with reversed short chain branch distribution (SCBD), can improve top load (stiffness), toughness, impact strength, and environmental stress crack resistance (ESCR), but they often lack the blow molding processability, melt strength and parison thickness and diameter swell needed during fabrication. Unimodal polyethylene polymers produced from a chromium-based catalyst system have good processability and polymer melt strength, typically due to their broad molecular weight distribution (MWD), but their containers often lack the toughness, impact strength, and ESCR.

A resin that delivers high ESCR, but is considered too difficult to process will struggle commercially. Processability of blow molded resins is related to the shape of the parison, or the extruded molten polymer after it leaves the die and before the molds close. Parison shape can be important for proper bottle formation and processing. Parison shape can be impacted by polymer swell, gravity, also referred to as sag, and geometry of the die and mandrel tooling. The parison shape is subject to change in the time period between die exit and closure of the molds. Swell is the result of the relaxation of the polymer melt upon exiting the die (elastic recovery of stored energy in the melt). Typically two types of die swell are observed: diameter swell and wall thickness swell. Diameter swell occurs immediately after resin exits the die and is the increase in parison diameter over the die diameter. Wall thickness swell is the increase in the thickness of the parison walls. There are many different types of blow molding machines and each subjects the molten polymer to different levels of shear forces, pressure, and orientation. As a result, predicting parison shape is quite complicated. On a laboratory scale, swell tests are performed in order to predict the shape of the parison. Unfortunately, there is not an absolute swell test beyond running the resin on the intended blow molding machine. Therefore, multiple swell tests are run to learn as much as possible about parison behavior. Evaluation of resins made using catalyst systems disclosed herein showed results for blow molding of large parts that were comparable to commercial resins, e.g., giving results for die-swell that were within five percent, ten percent, or twenty percent of values achieved for current commercial resins.

Another important balance for blow molded resins is between stiffness and toughness. These two attributes are inversely related to density. A higher density resin will deliver higher stiffness, but lower ESCR. Alternatively, a lower density resin will deliver lower stiffness and higher ESCR. The goal is to design a resin that offers both excellent ESCR and stiffness such that the large part can be light-weighted. When comparing two resins of the same density, an increased ESCR, despite a lower M_{z}/M_{w} ratio, would be unpredictable.

For another example, the die swell t1000 property of a polyethylene resin will vary depending upon the polymerization catalyst and gas phase polymerization conditions used. For satisfactory large-part blow-molding process performance, one of the properties needed by the polyethylene resin is satisfactory die swell t1000. Die swell t1000 is a complex swell measurement comprising a function of diameter swell and thickness swell. A die swell t1000 of about 9.5 to 10.5 seconds is desired for incumbent IBC resins being extruded in an IBC production line in order for the production line to transition between different IBC resins without having to change extrusion conditions and/or extruder hardware (e.g., die) and hardware settings (e.g., die gaps). If die swell t1000 of a new IBC resin is too high or too low, extrusion conditions and extruder hardware/settings may need to be changed when transitioning from the incumbent IBC resin to the new IBC resin in the production line. Picking a polymerization catalyst and a set of gas phase polymerization conditions for giving a pre-determined die swell t1000 is not predictable.

A similar lack of predictability applies to other resin properties such as z-average molecular weight (M_{z}), molecular weight distributions (e.g., M_{w}/Mₙ and M_{z}/M_{w}, wherein M_{w} is weight-average molecular weight, Mₙ is number-average molecular weight, and M_{z} is defined above), high load melt index (I₂₁), and zero shear viscosity (ZSV or n₀). These properties of a polyethylene resin will also vary with the polymerization catalyst and gas phase polymerization conditions used. When comparing two resins, increased processability (higher high load melt index), despite a higher M_{z} would be unpredictable. Increased melt strength, despite a lower zero shear viscosity, would be unpredictable. Increased t1000 die swell, despite a lower M_{z}/M_{w} ratio, would be unpredictable. Increased Mₙ, despite a lower M_{z}, would be unpredictable.

The industry still needs improved polymerization catalysts, improved gas phase polymerization process conditions, and improved polyethylene resins for containers, including intermediate bulk containers (IBCs).

We discovered a polymerization catalyst system that is prepared from the same metallocene and non-metallocene catalysts but in a different way from the preparation method used in WO 2020/223191 A1, can be used under controlled gas phase polymerization process conditions, which are different than those in WO 2020/223191 A1, to make an improved bimodal poly(ethylene-co-1-alkene) copolymer that has good processability, melt strength, parison thickness, and diameter swell suitable for extrusion blow molding manufacturing of large-part blow molded containers, including IBCs, that meet industry standards for top load (stiffness), toughness, impact strength, and ESCR. The copolymer comprises a higher molecular weight poly(ethylene-co-1-alkene) copolymer component (HMW copolymer component) and a lower molecular weight poly(ethylene-co-1-alkene) copolymer component (LMW copolymer component). The copolymer is characterized by a unique combination of features comprising, or reflected in, its component weight fraction amount, density, high load melt index, molecular weight distributions, viscoelastic properties, and environmental stress-cracking resistance, and impact strength. Additional inventive embodiments include a method of making the copolymer, a formulation comprising the copolymer and at least one additive that is different than the copolymer, a method of making a manufactured article, such as the intermediate bulk container, from the copolymer or formulation; the manufactured article, such as the IBC, made thereby, and use of the manufactured article (IBC). The inventive bimodal poly(ethylene-co-1-alkene) copolymer has, among other things, a unique balance of properties comprising M_{z}/M_{w} ratio, t1000 die swell, melt strength, Charpy impact strength, and environmental stress cracking resistance performance. Without being bound by theory, it is believed that the improved M_{z}/M_{w} ratio improves IBC performance in terms of increased top load (stiffness), increased toughness, increased impact strength, and/or increased environmental stress crack resistance.

### DETAILED DESCRIPTION

The bimodal poly(ethylene-co-1-alkene) copolymer is a composition of matter. The bimodal poly(ethylene-co-1-alkene) copolymer comprises a higher molecular weight poly(ethylene-co-1-alkene) copolymer component (HMW copolymer component) and a lower molecular weight poly(ethylene-co-1-alkene) copolymer component (LMW copolymer component). The 1-alkene is the same in the HMW and LMW components. The copolymer is characterized by a unique combination of features comprising, or reflected in, its component weight fraction amount, density, high load melt index, molecular weight distributions, viscoelastic properties, and environmental stress-cracking resistance, and impact strength. Embodiments of the copolymer may be characterized by refined or additional features and/or by features of one or both of its HMW and LMW copolymer components.

The bimodal poly(ethylene-co-1-alkene) copolymer is a so-called reactor copolymer because it is made in a single polymerization reactor using a bimodal catalyst system effective for simultaneously making the HMW and LMW copolymer components in situ. The bimodal catalyst system comprises a so-called high molecular weight-polymerization catalyst effective for making mainly the HMW copolymer component and a low molecular weight-polymerization catalyst effective for making mainly the LMW copolymer component. The high molecular weight-polymerization catalyst and the low molecular weight-polymerization catalyst operate under identical reactor conditions in a single polymerization reactor. It is believed that the intimate nature of the blend of the LMW and HMW copolymer components achieved in the bimodal poly(ethylene-co-1-alkene) copolymer by this in situ single reactor polymerization method could not be achieved by separately making the HMW copolymer component in the absence of the LMW copolymer component and separately making the LMW copolymer component in the absence of the HMW copolymer component, and then blending the separately made neat copolymer components together in a post-reactor process.

The bimodal poly(ethylene-co-1-alkene) copolymer is especially suitable for making Intermediate Bulk Containers (IBC). The inventive bimodal poly(ethylene-co-1-alkene) copolymer has, among other things, a unique balance of properties comprising M_{z}/M_{w} ratio, t1000 die swell, melt strength, Charpy impact strength, and environmental stress cracking resistance (ESCR) performance. The bimodal poly(ethylene-co-1-alkene) copolymer has the blow molding processability and polymer melt strength, and a good combination of stiffness, improved toughness, impact strength, and stress crack resistance. This enables manufacturing methods wherein the copolymer is melt-extruded and blow molded into large-part blow molded articles, which are larger, longer, and/or heavier than typical plastic parts. This improved performance enables the copolymer to be used not just for IBCs but also for geomembranes, pipes, and tanks. Nevertheless the copolymer is especially suited for making intermediate bulk containers or “IBCs”.

The characteristic features and resulting improved processability and performance of the bimodal poly(ethylene-co-1-alkene) copolymer are imparted by a unique combination of a bimodal catalyst system (designated “AFS-BMCS1” in the inventive examples) and a controlled relative amount of a trim catalyst solution (designated “TCS1” in the inventive examples) and controlled gas-phase polymerization conditions that are used to make the improved bimodal poly(ethylene-co-1-alkene) copolymer. The inventive bimodal poly(ethylene-co-1-alkene) copolymer has good processability, melt strength, parison thickness, and diameter swell suitable for large-part blow molding manufacturing of blow molded containers, including intermediate bulk containers, that meet industry standards for top load (stiffness), toughness, impact strength, and environmental stress crack resistance. Relative to Inventive Example 14 of WO 2020/223191 A1 (designated CE1 in the Examples), the inventive bimodal poly(ethylene-co-1-alkene) copolymer has two or more improved properties selected from the group consisting of: increased ESCR, despite a lower M_{z}/M_{w} ratio compared to that of CE1; good processability (comparable high load melt index); increased melt strength; increased t1000 die swell, despite a lower M_{z}/M_{w} ratio compared to that of CE1; and increased Mₙ, despite a lower M_{z} compared to that of CE1. These results are extra surprising when viewed with a conventional expectation that a higher M_{z}/M_{w} ratio would improve ESCR, toughness, and/or impact strength.

The inventive bimodal poly(ethylene-co-1-alkene) copolymer achieves this with a lower density. If density of the inventive bimodal poly(ethylene-co-1-alkene) copolymer would be too high, e.g., 0.950 to 0.957, then its impact performance and/or ESCR performance would be worsened. If density of the inventive bimodal poly(ethylene-co-1-alkene) copolymer would be too low, then the copolymer may not provide sufficient rigidity to an IBC container. The inventive bimodal poly(ethylene-co-1-alkene) copolymer has a M_{z}/M_{w} ratio (GPC_{(conv)}) of greater than 9.0 and a M_{z}/M_{w} ratio of greater than or equal to 5.0 (GPC_{(abs)}). If its M_{z}/M_{w} ratio is too low, then its die swell t1000 may be too low.

Additional inventive aspects follow; some are numbered below for ease of reference.

Aspect 1. A bimodal poly(ethylene-co-1-alkene) copolymer comprising from 25.5 weight percent (wt %) to 34.4 wt % of a higher molecular weight poly(ethylene-co-1-alkene) copolymer component (HMW copolymer component) and from 74.5 wt % to 65.6 wt %, respectively, of a lower molecular weight poly(ethylene-co-1-alkene) copolymer component (LMW copolymer component), and wherein the copolymer has each of properties (a) to (h): (a) a density from 0.942 to 0.949 gram per cubic centimeter (g/cm³) measured according to ASTM D792-13 (Method B, 2-propanol); (b) a high load melt index (HLMI or I₂₁) from 5.0 to 8.0 grams per 10 minutes (g/10 min.), alternatively from 5.0 to 7.9 g/10 min., measured according to ASTM D1238-13 (190° C., 21.6 kg); (c) a ratio of M_{w}/Mₙ from 8.1 to 10.1, wherein M_{w} is weight-average molecular weight and Mₙ is number-average molecular weight, both measured by Gel Permeation Chromatography (GPC) Test Method 2 (GPC_{(abs)}); (d) a ratio of M_{z}/M_{w} from 5.0 to 7.0, wherein M_{z} is z-average molecular weight and M_{w} is weight-average molecular weight, both measured by GPC Test Method 2 (GPC_{(abs)}); (e) a resin swell t1000 from 9.5 seconds to 10.5 seconds, measured according to Resin Swell t1000 Test Method; (f) an environmental stress cracking resistance (ESCR) greater than 900 hours, measured according to ASTM D1693-15, Method B (10% Igepal, F50); (g) a melt strength from 21 to 29 centinewtons (cN), measured at 190° C. by Melt Strength Test Method; and (h) a zero-shear viscosity (“n₀”) from 1,100 to 1,940 kilopascal-seconds (kPa-see), measured according to Zero Shear Viscosity Determination Method; and wherein the wt % of the HMW copolymer component and the wt % of the LMW copolymer component are calculated based on the combined weight of these components. In some embodiments the copolymer of aspect 1 also has at least one, alternatively each of properties (cc) and (dd): (cc) a ratio of M_{w}/Mₙ from 10.0 to 12.0, wherein M_{w} is weight-average molecular weight and Mₙ is number-average molecular weight, both measured by Gel Permeation Chromatography (GPC) Test Method 1 (GPC_{(conv)}); (dd) a ratio of M_{z}/M_{w} from 9.0 to 11.0, wherein M_{z} is z-average molecular weight and M_{w} is weight-average molecular weight, both measured by GPC Test Method 1 (GPC_{(conv)}).

Aspect 2. The bimodal poly(ethylene-co-1-alkene) copolymer of aspect 1, wherein the copolymer has at least one of properties (a1) to (h1): (a1) the density is from 0.944 to 0.948 g/cm³, alternatively from 0.946 to 0.948 g/cm³; (b1) the high load melt index (HLMI or 121) is from 5.0 to 7.4 g/10 min., alternatively from 5.7 to 7.0 g/10 min.; (c1) the ratio of M_{w}/Mₙ (GPC_{(abs)}) is from 8.7 to 9.5, alternatively from 8.9 to 9.3; (d1) the ratio of M_{z}/M_{w} (GPC_{(abs)}) is from 5.5 to 6.5, alternatively from 5.8 to 6.2; (e1) the resin swell t1000 is from 9.8 seconds to 10.4 seconds, alternatively from 10.0 seconds to 10.4 seconds; (f1) the environmental stress cracking resistance (ESCR) is greater than 1000 hours; (g1) the melt strength is from 23 to 27 cN; and (h1) the zero shear viscosity is from 1,350 to 1,540 kPa-sec. In some aspects the copolymer has at least properties (a1) and (b1); alternatively at least properties (a1) and (c1); alternatively at least properties (a1) and (d1); alternatively at least properties (a1) and (e1); alternatively at least properties (a1) and (f1); alternatively at least properties (a1) and (g1); alternatively at least properties (a1) and (h1). In some aspects the copolymer has at least properties (b1) and (c1); alternatively at least properties (b1) and (d1); alternatively at least properties (b1) and (e1); alternatively at least properties (b1) and (f1); alternatively at least properties (b1) and (g1); alternatively at least properties (b1) and (h1). In some aspects the copolymer has at least properties (c1) and (d1). In some aspects the copolymer has at least property (h1) and any one of properties (a1) to (g1). In some aspects the copolymer has each of properties (a1) to (h1). In some embodiments the copolymer of aspect 2 also has at least one, alternatively each of properties (cc1) and (dd1): (cc1) the ratio of M_{w}/Mₙ (GPC_{(conv)}) is from 10.5 to 11.4, alternatively from 10.7 to 11.1; (dd1) the ratio of M_{z}/M_{w} (GPC_{(conv)}) is from 9.0 to 10.4, alternatively from 9.4 to 9.8.

Aspect 3. The bimodal poly(ethylene-co-1-alkene) copolymer of aspect 1 or aspect 2, wherein the copolymer has at least one of properties (i) to (m): (i) a weight-average molecular weight (M_{w}) from 325,000 grams per mole (g/mol) to 440,000 g/mol, measured by the GPC Test Method 2 (GPC_{(abs)}); (j) a number-average molecular weight (Mₙ) from 33,000 g/mol to 47,000 g/mol, measured by the GPC Test Method 2 (GPC_{(abs)}); (k) a z-average molecular weight (M_{z}) from 1,600,000 g/mol to 2,900,000 g/mol, measured by the GPC Test Method 2 (GPC_{(abs)}); (I) a Charpy impact strength from 38 to 45 kilojoules per square meter (kJ/m²), measured at −40° C. according to ISO 179; and (m) a 2% secant modulus from 701 megapascals (MPa) to 930 MPa, measured according to ASTM D882-12. In some aspects the copolymer has properties (i) and (j); alternatively (i) and (k); alternatively (i) and (I); alternatively (i) and (m). In some aspects the copolymer has properties (k) and (j); alternatively (k) and (I); alternatively (k) and (m). In some aspects the copolymer has properties (i), (j), and (k). In some aspects the copolymer has each of properties (i) to (m). In some embodiments the copolymer of aspect 3 also has at least one, alternatively each of properties (ii) to (kk): (ii) a weight-average molecular weight (M_{w}) from 350,000 grams per mole (g/mol) to 490,000 g/mol; (jj) a number-average molecular weight (Mₙ) from 35,000 g/mol to 49,000 g/mol; and (kk) a z-average molecular weight (M_{z}) from 4,100,000 g/mol to 5,000,000 g/mol; all measured by the GPC Test Method 1 (GPC_{(conv)}).

Aspect 4. The bimodal poly(ethylene-co-1-alkene) copolymer of aspect 3, wherein the copolymer has at least one of properties (i1) to (m1): (i1) the weight-average molecular weight (M_{w}) (GPC_{(abs)}) is from 330,000 g/mol to 420,000 g/mol, alternatively from 350,000 g/mol to 390,000 g/mol; (j1) the number-average molecular weight (Mₙ) (GPC_{(abs)}) is from 35,000 g/mol to 45,000 g/mol, alternatively from 38,000 g/mol to 42,000 g/mol; (k1) the z-average molecular weight (M_{z}) (GPC_{(abs)}) is from 1,900,000 g/mol to 2,700,000 g/mol, alternatively from 2,050,000 g/mol to 2,400,000 g/mol; (l1) the Charpy impact strength is from 40.0 to 44.0 kJ/m²; and (m1) the 2% secant modulus is from 740 MPa to 899 MPa, alternatively from 760 MPa to 840 MPa. In some aspects the copolymer has properties (i1) and (j1); alternatively (i1) and (k1); alternatively (i1) and (l1); alternatively (i1) and (m1). In some aspects the copolymer has properties (k1) and (j1); alternatively (k1) and (l1); alternatively (k1) and (m1). In some aspects the copolymer has properties (i1), (j1), and (k1). In some aspects the copolymer has each of properties (i1) to (m1). In some embodiments the copolymer of aspect 4 also has at least one, alternatively each of properties (ii1) to (kk1): (ii1) the weight-average molecular weight (M_{w}) (GPC_{(conv)}) is from 380,000 g/mol to 480,000 g/mol, alternatively from 450,000 g/mol to 464,000 g/mol; (jj1) the number-average molecular weight (Mₙ) (GPC_{(conv)}) is from 38,000 g/mol to 44,000 g/mol; (kk1) the z-average molecular weight (M_{z}) (GPC_{(conv)}) is from 4,300,000 g/mol to 4,900,000 g/mol.

Aspect 5. The bimodal poly(ethylene-co-1-alkene) copolymer of aspect 4, wherein the bimodal poly(ethylene-co-1-alkene) copolymer has each of properties (a1) to (h1) and at least one, alternatively each of properties (i1) to (m1). In some embodiments the copolymer has properties (a1) to (i1); alternatively (a1) to (h1) and (j1); alternatively (a1) to (h1) and (k1); alternatively (a1) to (h1) and (l1); alternatively (a1) to (h1) and (m1).

Aspect 6. The bimodal poly(ethylene-co-1-alkene) copolymer of any one of aspects 1 to 5 comprising from 27 wt % to 33 wt % of the HMW copolymer component and from 73 wt % to 67 wt %, respectively, of the LMW copolymer component; alternatively from 28 wt % to 32 wt % of the HMW copolymer component and from 72 wt % to 68 wt %, respectively, of the LMW copolymer component.

Aspect 7. A method of making the bimodal poly(ethylene-co-1-alkene) copolymer of any one of aspects 1 to 6, the method comprising contacting ethylene and 1-alkene with a bimodal catalyst system and a controlled relative amount of a trim catalyst solution in a single gas phase polymerization (GPP) reactor under effective polymerization conditions to give the bimodal poly(ethylene-co-1-alkene) copolymer; wherein the bimodal catalyst system consists essentially a metallocene catalyst, a single-site non-metallocene catalyst that is a bis((alkyl-substituted phenylamido)ethyl)amine catalyst, a support material, and an activator; wherein the support material is a hydrophobized fumed silica; wherein the metallocene catalyst is an activation reaction product of contacting an activator with a metal-ligand complex of formula (I): (R¹ₓCp)((alkyl)_{y}Indenyl)MX₂ (I), wherein subscript x is 0 or 1; each R¹ independently is methyl or ethyl; subscript y is 1, 2, or 3; each alkyl independently is a (C₁-C₄)alkyl; M is titanium, zirconium, or hafnium; and each X is independently a halide, a (C₁ to C₂₀)alkyl, a (C₇ to C₂₀)aralkyl, a (C₁ to C₆)alkyl-substituted (C₆ to C₁₂)aryl, or a (C₁ to C₆)alkyl-substituted benzyl; wherein the bis((alkyl-substituted phenylamido)ethyl)amine catalyst is an activation reaction product of contacting an activator with a bis((alkyl-substituted phenylamido)ethyl)amine ZrR₂, wherein each R is independently selected from F, Cl, Br, I, benzyl, —CH₂Si(CH₃)₃, a (C₁-C₅)alkyl, and a (C₂-C₅)alkenyl; and wherein the trim catalyst solution is an additional amount of the metallocene catalyst and/or the metal-ligand complex of formula (I) dissolved in an alkane (e.g., hexane or mineral oil; and wherein the method controls properties (a) density and (b) high load melt index of the bimodal poly(ethylene-co-1-alkene) copolymer by the controlling the amount of the trim catalyst solution relative to the amount of the bimodal catalyst system in the contacting step. The controlling the amount of the trim catalyst solution relative to the amount of the bimodal catalyst system in the contacting step is what is meant by the “controlled relative amount of a trim catalyst solution”.

Aspect 8. The method of aspect 7, wherein the metal-ligand complex of formula (I) is of formula (Ia):

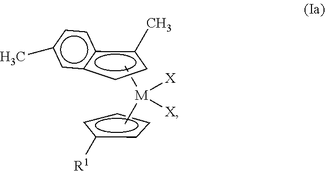

wherein R¹ is H, M is Zr, and each X is as defined therein; and wherein the bis((alkyl-substituted phenylamido)ethyl)amine ZrR₂ is of formula (II):

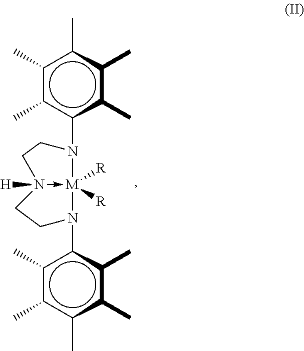

wherein each R is benzyl. In some embodiments the bimodal catalyst system is AFS-BMCS1 and the trim catalyst solution is TCS1 described in the inventive Example(s).

Aspect 9. A formulation comprising the bimodal poly(ethylene-co-1-alkene) copolymer of any one of aspects 1 to 6 and at least one additive that is different than the copolymer, wherein the at least one additive comprises an antioxidant. The at least one additive may further comprise a second antioxidant and/or an ultraviolet (UV) light stabilizer.

Aspect 10. An intermediate bulk container comprising the bimodal poly(ethylene-co-1-alkene) copolymer of any one of aspects 1 to 6 or the formulation of claim 9. The intermediate bulk container (IBC) may be dimensioned to define a volume from 8 to 1,250 liters, alternatively from 8 to 220 liters, alternatively from 250 to 1,000 liters, alternatively from to 1,040 to 1,250 liters. The IBC may be flexible or rigid, alternatively rigid. The IBC may be used to store or transport bulk chemicals, raw materials, food ingredients, petrochemicals, rainwater, paint, industrial coatings, pharmaceutical compounds, wine, spirits, or waste materials.

Aspect 11. A method of making the intermediate bulk container of aspect 10, the method comprising extruding-melt-blowing the bimodal poly(ethylene-co-1-alkene) copolymer under large-part blow molding conditions so as to make the intermediate bulk container, wherein the extruding-melt-blowing of the bimodal poly(ethylene-co-1-alkene) copolymer comprises conveying a melt of the bimodal poly(ethylene-co-1-alkene) copolymer, optionally containing at least one additive, into a mold cavity; forcing compressed air into the mold, thereby creating a hollow recess in the molded melt mixture; and cooling the resulting molded article to make the intermediate bulk container. In some aspects the bimodal poly(ethylene-co-1-alkene) copolymer is provided in the form of the formulation of aspect 9. The IBC may be made by blow molding. The method comprises feeding pellets of the inventive copolymer or formulation and any additives into a single- or twin-screw extruder; melting the copolymer and mixing it with the additives, if any; conveying the melt mixture into a mold cavity; forcing compressed air into the mold, thereby creating a hollow recess in the molded melt mixture; and cooling the resulting molded IBC. The resulting IBC is removed from the molding machine and trimmed of any imperfections.

The invention of any one of aspects 1 to 11 wherein the bimodal poly(ethylene-co-1-alkene) copolymer is a bimodal poly(ethylene-co-1-hexene) copolymer.

The invention of any one of the above aspects wherein the bimodal poly(ethylene-co-1-alkene) copolymer has a notched constant ligament stress (nCLS) of from 201 to 600 hours, alternatively from 401 to 540 hours, alternatively from 451 to 499 hours, measured according to the nCLS Test Method described later.

In some embodiments the bimodal poly(ethylene-co-1-alkene) copolymer has a melt index (1₂) less than 0.15 g/10 min. measured at 190° C. and 2.16 kg according to ASTM D1238-13. A melt index (1₂) less than 0.15 g/10 min. is below the minimum value that may be reliably measured by ASTM D1238-13. Thus this value is intended to distinguish the inventive bimodal poly(ethylene-co-1-alkene) copolymer from non-inventive bimodal poly(ethylene-co-1-alkene) copolymers that do have a measurable melt index (1₂) of 0.15 g/10 min. or greater.

The single gas phase polymerization reactor may be a fluidized-bed gas phase polymerization (FB-GPP) reactor and the effective polymerization conditions may comprise conditions (a) to (e): (a) the FB-GPP reactor having a fluidized resin bed at a bed temperature from 80 to 104 degrees Celsius (° C.), alternatively from 95 to 103° C., alternatively from 98 to 102° C., alternatively from 99 to 101° C. (e.g., 100° C.); (b) the FB-GPP reactor receiving feeds of respective independently controlled amounts of ethylene, 1-alkene characterized by a 1-alkene-to-ethylene (Cₓ/C₂, wherein subscript x indicates the number of carbon atoms in the 1-alkene; for example, when the 1-alkene is 1-hexene, the Cₓ/C₂ ratio is the 1-hexene-to-ethylene ratio, which may be written as a C₆/C₂ ratio) molar ratio, the bimodal catalyst system, optionally a trim catalyst solution comprising a solution in an inert hydrocarbon liquid of a dissolved amount of unsupported form of the metallocene catalyst made from the metal-ligand complex of formula (I), alternatively formula (Ia), and activator, optionally hydrogen gas (H₂) characterized by a hydrogen-to-ethylene (H₂/C₂) molar ratio or by a weight parts per million H₂ to mole percent C₂ ratio (H₂ ppm/C₂ mol %), and optionally an induced condensing agent (ICA) comprising a (C₅-C₁₀)alkane(s), e.g., isopentane; wherein the (C₆/C₂) molar ratio is from 0.0010 to 0.1, alternatively from 0.0015 to 0.0040, alternatively from 0.0022 to 0.0031, alternatively from 0.0026 to 0.0028 (e.g., 0.0027); wherein when H₂ is fed, the H₂/C₂ molar ratio is from 0.0001 to 0.0014, alternatively from 0.0002 to 0.0009, alternatively from 0.00030 to 0.00070, alternatively from 0.00040 to 0.00060 (e.g., 0.0005); and wherein when the ICA is fed, the concentration of ICA in the reactor is from 1 to 20 mole percent (mol %), alternatively from 3.0 to 9.0 mol %, alternatively from 4.4 to 6.9 mol %, alternatively from 5.1 to 6.1 mol % (e.g., 5.6 mol %), based on total moles of ethylene, 1-alkene, and ICA in the reactor. The average residence time of the copolymer in the reactor may be from 1.5 to 3.4 hours, alternatively from 2.1 to 3.1 hours, alternatively from 2.4 to 2.8 hours (e.g., 2.6 hours). A continuity additive may be used in the FB-GPP reactor during polymerization.

The bimodal catalyst system may be characterized by an inverse response to bed temperature such that when the bed temperature is increased, the zero shear viscosity value (a viscoelastic property) of the resulting bimodal poly(ethylene-co-1-alkene) copolymer is decreased, and when the bed temperature is decreased, the zero shear viscosity value of the resulting bimodal poly(ethylene-co-1-alkene) copolymer is increased. The bimodal catalyst system may be characterized by an inverse response to the H₂/C₂ ratio such that when the H₂/C₂ ratio is increased, the zero shear viscosity value of the resulting bimodal poly(ethylene-co-1-alkene) copolymer is decreased, and when the H₂/C₂ ratio is decreased, the zero shear viscosity value of the resulting bimodal poly(ethylene-co-1-alkene) copolymer is increased. For example, in the foregoing the 1-alkene may be 1-hexene.

The bimodal poly(ethylene-co-1-alkene) copolymer comprises the higher molecular weight poly(ethylene-co-1-alkene) copolymer component (HMW copolymer component) and the lower molecular weight poly(ethylene-co-1-alkene) copolymer component (LMW copolymer component). The “higher” and “lower” descriptions mean the weight-average molecular weight of the HMW copolymer component (M_{w}H) is greater than the weight-average molecular weight of the LMW copolymer component (M_{w}L). The bimodal poly(ethylene-co-1-alkene) copolymer is characterized by a bimodal weight-average molecular weight distribution (bimodal M_{w} distribution) as determined by gel permeation chromatography (GPC), described later. The bimodal M_{w} distribution is not unimodal because the copolymer is made by two distinctly different catalysts. The copolymer may be characterized by two peaks in a plot of dW/d Log(MW) on the y-axis versus Log(MW) on the x-axis to give a Gel Permeation Chromatograph (GPC) chromatogram, wherein Log(MW) and dW/d Log(MW) are as defined herein and are measured by the GPC Test Method described later. The two peaks may be separated by a distinguishable local minimum therebetween or one peak may merely be a shoulder on the other.

The 1-alkene used to make the inventive bimodal poly(ethylene-co-1-alkene) copolymer may be a (C₄-C₈)alpha-olefin, or a combination of any two or more (C₄-C₈)alpha-olefins. Each (C₄-C₈)alpha-olefin independently may be 1-butene, 1-pentene, 1-hexene, 4-methyl-1-pentene, 1-heptene, or 1-octene; alternatively 1-butene, 1-hexene, or 1-octene; alternatively 1-butene or 1-hexene; alternatively 1-hexene or 1-octene; alternatively 1-butene; alternatively 1-hexene; alternatively 1-octene; alternatively a combination of 1-butene and 1-hexene; alternatively a combination of 1-hexene and 1-octene. The 1-alkene may be 1-hexene and the bimodal poly(ethylene-co-1-alkene) copolymer may be a bimodal poly(ethylene-co-1-hexene) copolymer. Or the 1-alkene may be 1-butene and the bimodal poly(ethylene-co-1-alkene) copolymer may be a bimodal poly(ethylene-co-1-butene) copolymer. When the 1-alkene is a combination of two (C₄-C₈)alpha-olefins, the bimodal poly(ethylene-co-1-alkene) copolymer is a bimodal poly(ethylene-co-1-alkene) terpolymer.

Embodiments of the formulation may comprise a blend of the inventive bimodal poly(ethylene-co-1-alkene) copolymer and polyethylene that is not the inventive bimodal poly(ethylene-co-1-alkene) copolymer. The polyethylene that is not the bimodal poly(ethylene-co-1-alkene) copolymer may be a polyethylene homopolymer or a different bimodal ethylene/alpha-olefin copolymer. The alpha-olefin used to make the different bimodal ethylene/alpha-olefin copolymer may be a (C₃-C₂₀)alpha-olefin, alternatively a (C₄-C₈)alpha-olefin; alternatively 1-butene, 1-hexene, or 1-octene; alternatively 1-butene; alternatively 1-hexene; alternatively 1-octene. When 1-hexene is used to make the different bimodal ethylene/alpha-olefin copolymer, in order for the latter copolymer to be different than the inventive copolymer, a bimodal catalyst system is used that is free of the metallocene catalyst made from the metal-ligand complex of formula (I), alternatively formula (Ia), and activator to make the different bimodal ethylene/alpha-olefin copolymer.

In an illustrative pilot plant process for making the bimodal polyethylene polymer, a fluidized bed, gas-phase polymerization reactor (“FB-GPP reactor”) having a reaction zone dimensioned as 304.8 mm (twelve inch) internal diameter and a 2.4384 meter (8 feet) in straight-side height and containing a fluidized bed of granules of the bimodal polyethylene polymer. Configure the FB-GPP reactor with a recycle gas line for flowing a recycle gas stream. Fit the FB-GPP reactor with gas feed inlets and polymer product outlet. Introduce gaseous feed streams of ethylene and hydrogen together with 1-alkene comonomer (e.g., 1-hexene) below the FB-GPP reactor bed into the recycle gas line. Measure the (C₅-C₂₀)alkane(s) total concentration in the gas/vapor effluent by sampling the gas/vapor effluent in the recycle gas line. Return the gas/vapor effluent (other than a small portion removed for sampling) to the FB-GPP reactor via the recycle gas line.

Polymerization operating conditions are any variable or combination of variables that may affect a polymerization reaction in the GPP reactor or a composition or property of a bimodal polyethylene copolymer made thereby. The variables may include reactor design and size, catalyst composition and amount; reactant composition and amount; molar ratio of two different reactants; presence or absence of feed gases such as H₂ and/or O₂, molar ratio of feed gases versus reactants, absence or concentration of interfering materials (e.g., H₂O), average polymer residence time in the reactor, partial pressures of constituents, feed rates of monomers, reactor bed temperature (e.g., fluidized bed temperature), nature or sequence of process steps, time periods for transitioning between steps. Variables other than that/those being described or changed by the method or use may be kept constant.

In operating the method, control individual flow rates of ethylene (“C₂”), 1-alkene (“Cₓ”, e.g., 1-hexene or “C₆” or “Cₓ” wherein x is 6), and any hydrogen (“H₂”) to maintain a fixed comonomer to ethylene monomer gas molar ratio (Cₓ/C₂, e.g., C₆/C₂) equal to a described value, a constant hydrogen to ethylene gas molar ratio (“H₂/C₂”) equal to a described value, and a constant ethylene (“C₂”) partial pressure equal to a described value (e.g., 1,000 kPa). Measure concentrations of gases by an in-line gas chromatograph to understand and maintain composition in the recycle gas stream. Maintain a reacting bed of growing polymer particles in a fluidized state by continuously flowing a make-up feed and recycle gas through the reaction zone. Use a superficial gas velocity of 0.49 to 0.67 meter per second (m/sec) (1.6 to 2.2 feet per second (ft/sec)). Operate the FB-GPP reactor at a total pressure of about 2344 to about 2420 kilopascals (kPa) (about 340 to about 351 pounds per square inch-gauge (psig)) and at a described reactor bed temperature RBT. Maintain the fluidized bed at a constant height by withdrawing a portion of the bed at a rate equal to the rate of production of particulate form of the bimodal polyethylene polymer, which production rate may be from 10 to 20 kilograms per hour (kg/hr), alternatively 13 to 18 kg/hr. Remove the produced bimodal poly(ethylene-co-1-alkene) copolymer semi-continuously via a series of valves into a fixed volume chamber, and purge the removed composition with a stream of humidified nitrogen (N₂) gas to remove entrained hydrocarbons and deactivate any trace quantities of residual catalysts.

The bimodal catalyst system may be fed into the polymerization reactor(s) in “dry mode” or “wet mode”, alternatively dry mode, alternatively wet mode. The dry mode is a dry powder or granules. The wet mode is a suspension in an inert liquid such as mineral oil or the (C₅-C₂₀)alkane(s).

In some aspects bimodal poly(ethylene-co-1-alkene) copolymer is made by contacting the metal-ligand complex of formula (I), alternatively formula (Ia), and the single-site non-metallocene catalyst with at least one activator in situ in the GPP reactor in the presence of olefin monomer and 1-alkene comonomer (e.g., ethylene and 1-hexene) and growing polymer chains. These embodiments may be referred to herein as in situ-contacting embodiments. In other aspects the metal-ligand complex of formula (I), alternatively formula (Ia); the single-site non-metallocene catalyst; hydrophobized fumed silica; and the at least one activator are pre-mixed together for a period of time to make an activated bimodal catalyst system, and then the activated bimodal catalyst system is injected into the GPP reactor, where it contacts the olefin monomer and growing polymer chains. These latter embodiments pre-contact the metal-ligand complex of formula (I), alternatively formula (Ia); the single-site non-metallocene catalyst, and the at least one activator together in the absence of olefin monomer (e.g., in absence of ethylene and alpha-olefin) and growing polymer chains, i.e., in an inert environment, and are referred to herein as pre-contacting embodiments. The pre-mixing period of time of the pre-contacting embodiments may be from 1 second to 10 minutes, alternatively from 30 seconds to 5 minutes, alternatively from 30 seconds to 2 minutes.

The ICA may be fed separately into the FB-GPP reactor or as part of a mixture also containing the bimodal catalyst system. The ICA may be a (C₁₁-C₂₀)alkane, alternatively a (C₅-C₁₀)alkane, alternatively a (C₅)alkane, e.g., pentane or 2-methylbutane; a hexane; a heptane; an octane; a nonane; a decane; or a combination of any two or more thereof. The aspects of the polymerization method that use the ICA may be referred to as being an induced condensing mode operation (ICMO). ICMO is described in U.S. Pat. Nos. 4,453,399; 4,588,790; 4,994,534; 5,352,749; 5,462,999; and 6,489,408. The concentration of ICA in the reactor is measured indirectly as total concentration of vented ICA in recycle line using gas chromatography by calibrating peak area percent to mole percent (mol %) with a gas mixture standard of known concentrations of ad rem gas phase components.

The method uses a gas-phase polymerization (GPP) reactor, such as a stirred-bed gas phase polymerization reactor (SB-GPP reactor) or a fluidized-bed gas-phase polymerization reactor (FB-GPP reactor), to make the bimodal poly(ethylene-co-1-alkene) copolymer. Such gas phase polymerization reactors and methods are generally well-known in the art. For example, the FB-GPP reactor/method may be as described in U.S. Pat. Nos. 3,709,853; 4,003,712; 4,011,382; 4,302,566; 4,543,399; 4,882,400; 5,352,749; 5,541,270; EP-A-0 802 202; and Belgian Patent No. 839,380. These SB-GPP and FB-GPP polymerization reactors and processes either mechanically agitate or fluidize by continuous flow of gaseous monomer and diluent the polymerization medium inside the reactor, respectively. Other useful reactors/processes contemplated include series or multistage polymerization processes such as described in U.S. Pat. Nos. 5,627,242; 5,665,818; 5,677,375; EP-A-0 794 200; EP-B1-0 649 992; EP-A-0 802 202; and EP-B-634421.

The polymerization conditions may further include one or more additives such as a chain transfer agent or a promoter. The chain transfer agents are well known and may be alkyl metal such as diethyl zinc. Promoters are known such as in U.S. Pat. No. 4,988,783 and may include chloroform, CFCl₃, trichloroethane, and difluorotetrachloroethane. Prior to reactor start up, a scavenging agent may be used to react with moisture and during reactor transitions a scavenging agent may be used to react with excess activator. Scavenging agents may be a trialkylaluminum. Gas phase polymerizations may be operated free of (not deliberately added) scavenging agents. The polymerization conditions for gas phase polymerization reactor/method may further include an amount (e.g., 0.5 to 200 ppm based on all feeds into reactor) of a static control agent and/or a continuity additive such as aluminum stearate or polyethyleneimine. The static control agent may be added to the FB-GPP reactor to inhibit formation or buildup of static charge therein.

The method may use a pilot scale fluidized bed gas phase polymerization reactor (Pilot Reactor) that comprises a reactor vessel containing a fluidized bed of a powder of the bimodal polyethylene polymer, and a distributor plate disposed above a bottom head, and defining a bottom gas inlet, and having an expanded section, or cyclone system, at the top of the reactor vessel to decrease amount of resin fines that may escape from the fluidized bed. The expanded section defines a gas outlet. The Pilot Reactor further comprises a compressor blower of sufficient power to continuously cycle or loop gas around from out of the gas outlet in the expanded section in the top of the reactor vessel down to and into the bottom gas inlet of the Pilot Reactor and through the distributor plate and fluidized bed. The Pilot Reactor further comprises a cooling system to remove heat of polymerization and maintain the fluidized bed at a target temperature. Compositions of gases such as ethylene, 1-alkene (e.g., 1-hexene), and hydrogen being fed into the Pilot Reactor are monitored by an in-line gas chromatograph in the cycle loop in order to maintain specific concentrations thereof that define and enable control of polymer properties. The bimodal catalyst system may be fed as a slurry or dry powder into the Pilot Reactor from high pressure devices, wherein the slurry is fed via a syringe pump and the dry powder is fed via a metered disk. The bimodal catalyst system typically enters the fluidized bed in the lower ⅓ of its bed height. The Pilot Reactor further comprises a way of weighing the fluidized bed and isolation ports (Product Discharge System) for discharging the powder of bimodal polyethylene polymer from the reactor vessel in response to an increase of the fluidized bed weight as polymerization reaction proceeds.

In some embodiments the FB-GPP reactor is a commercial scale reactor such as a UNIPOL™ reactor, which is available from Univation Technologies, LLC, a subsidiary of The Dow Chemical Company, Midland, Michigan, USA.

The bimodal catalyst system used in the method consists essentially of the metallocene catalyst and the bis((alkyl-substituted phenylamido)ethyl)amine ZrR¹₂ catalyst, and, optionally, the support material; wherein the support material, when present, is selected from the at least one of the inert hydrocarbon liquid and the solid support; wherein the metallocene catalyst is an activation reaction product of contacting an activator with a metal-ligand complex of formula (I) described earlier; and wherein the bis((alkyl-substituted phenylamido)ethyl)amine catalyst is an activation reaction product of contacting an activator with the bis((alkyl-substituted phenylamido)ethyl)amine ZrR¹₂ catalyst described earlier. The phrase consists essentially of means that the bimodal catalyst system and method using same is free of a third single-site catalyst (e.g., a different metallocene, a different amine catalyst, or a biphenylphenolic catalyst) and free of non-single site catalysts (e.g., free of Ziegler-Natta or chromium catalysts). The bimodal catalyst system may also consist essentially of the support material and/or at least one activator species, which is a by-product of reacting the metallocene catalyst or non-metallocene molecular catalyst with the activator(s).

Without being bound by theory, it is believed that the bis((alkyl-substituted phenylamido)ethyl)amine catalyst (e.g., the bis(2-(pentamethylphenylamido)ethyl)amine zirconium dibenzyl) is a substantially single-site non-metallocene catalyst that is effective for making the HMW copolymer component of the bimodal poly(ethylene-co-1-alkene) copolymer and the metallocene catalyst (made from the metal-ligand complex of formula (I)) is a substantially single-site catalyst that is independently effective for making the LMW copolymer component of the bimodal poly(ethylene-co-1-alkene) copolymer. The molar ratio of the two catalysts of the bimodal catalyst system may be based on the molar ratio of their respective catalytic metal atom (M, e.g., Zr) contents, which may be calculated from ingredient weights thereof or may be analytically measured. The molar ratio of the two catalysts may be varied in the polymerization method by way of using a different bimodal catalyst system formulation having different molar ratio thereof or by using a same bimodal catalyst system and the trim catalyst solution. Varying the molar ratio of the two catalysts during the polymerization method may be used to vary the particular properties of the bimodal poly(ethylene-co-1-alkene) copolymer within the limits of the described features thereof.

The catalysts of the bimodal catalyst system may be unsupported when contacted with an activator, which may be the same or different for the different catalysts. Alternatively, the catalysts may be disposed by spray-drying onto a solid support material prior to being contacted with the activator(s). The solid support material may be uncalcined or calcined prior to being contacted with the catalysts. The solid support material may be a hydrophobic fumed silica (e.g., a fumed silica treated with dimethyldichlorosilane). The bimodal (unsupported or supported) catalyst system may be in the form of a powdery, free-flowing particulate solid.

Support material. The support material may be an inorganic oxide material. The terms “support” and “support material” are the same as used herein and refer to a porous inorganic substance or organic substance. In some embodiments, desirable support materials may be inorganic oxides that include Group 2, 3, 4, 5, 13 or 14 oxides, alternatively Group 13 or 14 atoms. Examples of inorganic oxide-type support materials are silica, alumina, titania, zirconia, thoria, and mixtures of any two or more of such inorganic oxides. Examples of such mixtures are silica-chromium, silica-alumina, and silica-titania.

The inorganic oxide support material is porous and has variable surface area, pore volume, and average particle size. In some embodiments, the surface area is from 50 to 1000 square meter per gram (m²/g) and the average particle size is from 20 to 300 micrometers (μm). Alternatively, the pore volume is from 0.5 to 6.0 cubic centimeters per gram (cm³/g) and the surface area is from 200 to 600 m²/g. Alternatively, the pore volume is from 1.1 to 1.8 cm³/g and the surface area is from 245 to 375 m²/g. Alternatively, the pore volume is from 2.4 to 3.7 cm³/g and the surface area is from 410 to 620 m²/g. Alternatively, the pore volume is from 0.9 to 1.4 cm³/g and the surface area is from 390 to 590 m²/g. Each of the above properties are measured using conventional techniques known in the art.

The support material may comprise silica, alternatively amorphous silica (not quartz), alternatively a high surface area amorphous silica (e.g., from 500 to 1000 m²/g). Such silicas are commercially available from several sources including the Davison Chemical Division of W.R. Grace and Company (e.g., Davison 952 and Davison 955 products), and PQ Corporation (e.g., ES70 product). The silica may be in the form of spherical particles, which are obtained by a spray-drying process. Alternatively, MS3050 product is a silica from PQ Corporation that is not spray-dried. As procured, these silicas are not calcined (i.e., not dehydrated). Silica that is calcined prior to purchase may also be used as the support material.

Prior to being contacted with a catalyst, the support material may be pre-treated by heating the support material in air to give a calcined support material. The pre-treating comprises heating the support material at a peak temperature from 350° to 850° C., alternatively from 400° to 800° C., alternatively from 400° to 700° C., alternatively from 500° to 650° C. and for a time period from 2 to 24 hours, alternatively from 4 to 16 hours, alternatively from 8 to 12 hours, alternatively from 1 to 4 hours, thereby making a calcined support material. The support material may be a calcined support material.

The method may further employ a trim catalyst, typically in the form of a trim catalyst solution as described elsewhere herein. The trim catalyst may be any one of the aforementioned metallocene catalysts made from the metal-ligand complex of formula (I) and activator. For convenience the trim catalyst is fed in solution in a hydrocarbon solvent (e.g., mineral oil or heptane). The hydrocarbon solvent may be the ICA. The trim catalyst may be made from the same metal-ligand complex of formula (I) as that used to make the metallocene catalyst of the bimodal catalyst system, alternatively the trim catalyst may be made from a different metal-ligand complex of formula (I) than that used to make the metallocene catalyst of the bimodal catalyst system. The trim catalyst may be used to vary, within limits, the amount of the metallocene catalyst used in the method relative to the amount of the single-site non-metallocene catalyst of the bimodal catalyst system.

Each catalyst of the bimodal catalyst system is activated by contacting it with an activator. Any activator may be the same or different as another and independently may be a Lewis acid, a non-coordinating ionic activator, or an ionizing activator, or a Lewis base, an alkylaluminum, or an alkylaluminoxane (alkylalumoxane). The alkylaluminum may be a trialkylaluminum, alkylaluminum halide, or alkylaluminum alkoxide (diethylaluminum ethoxide). The trialkylaluminum may be trimethylaluminum, triethylaluminum (“TEAl”), tripropylaluminum, or tris(2-methylpropyl)aluminum. The alkylaluminum halide may be diethylaluminum chloride. The alkylaluminum alkoxide may be diethylaluminum ethoxide. The alkylaluminoxane may be a methylaluminoxane (MAO), ethylaluminoxane, 2-methylpropyl-aluminoxane, or a modified methylaluminoxane (MMAO). Each alkyl of the alkylaluminum or alkylaluminoxane independently may be a (C₁-C₇)alkyl, alternatively a (C₁-C₆)alkyl, alternatively a (C₁-C₄)alkyl. The molar ratio of activator's metal (Al) to a particular catalyst compound's metal (catalytic metal, e.g., Zr) may be 1000:1 to 0.5:1, alternatively 300:1 to 1:1, alternatively 150:1 to 1:1. Suitable activators are commercially available.

Once the activator and the catalysts of the bimodal catalyst system contact each other, the catalysts of the bimodal catalyst system are activated and activator species may be made in situ. The activator species may have a different structure or composition than the catalyst and activator from which it is derived and may be a by-product of the activation of the catalyst or may be a derivative of the by-product. The corresponding activator species may be a derivative of the Lewis acid, non-coordinating ionic activator, ionizing activator, Lewis base, alkylaluminum, or alkylaluminoxane, respectively. An example of the derivative of the by-product is a methylaluminoxane species that is formed by devolatilizing during spray-drying of a bimodal catalyst system made with methylaluminoxane.

Each contacting step between activator and catalyst independently may be done either in a separate vessel outside the GPP reactor (e.g., outside the FB-GPP reactor) or in a feed line to the GPP reactor. In option (a) the bimodal catalyst system, once its catalysts are activated, may be fed into the GPP reactor as a dry powder, alternatively as a slurry in a non-polar, aprotic (hydrocarbon) solvent. The activator(s) may be fed into the reactor in “wet mode” in the form of a solution thereof in an inert liquid such as mineral oil or toluene, in slurry mode as a suspension, or in dry mode as a powder. Each contacting step may be done at the same or different times.

The relative terms “higher” and “lower” in HMW and LMW are used in reference to each other and merely mean that the weight-average molecular weight of the HMW component (M_{w-HMW}) is greater than the weight-average molecular weight of the LMW component (M_{w-LMW}), i.e., M_{w-HMW}>M_{w-LMW}.

Activator. Substance, other than a catalyst or monomer, that increases the rate of a catalyzed reaction without itself being consumed. May contain aluminum and/or boron.

Bimodal in reference to a polymer may be characterized by a bimodal molecular weight distribution (bimodal MWD) as determined by gel permeation chromatography (GPC). The bimodal MWD may be characterized as two peaks in a plot of dW/d Log(MW) on the y-axis versus Log(MW) on the x-axis to give a Gel Permeation Chromatograph (GPC) chromatogram, wherein Log(MW) and dW/d Log(MW) are as defined herein and are measured by the GPC Test Method described later. The two peaks may be separated by a distinguishable local minimum therebetween or one peak may merely be a shoulder on the other, or both peaks may partly overlap so as to appear is a single GPC peak.

Copolymer. A macromolecule having constituent units derived from polymerizing a monomer and at least comonomer, which is different in structure than the monomer. Herein the monomer is ethylene and the comonomer is 1-alkene, e.g., 1-hexene.

Dry. Generally, a moisture content from 0 to less than 5 parts per million based on total parts by weight. Materials fed to the reactor(s) during a polymerization reaction are dry.

Feed. Quantity of reactant or reagent that is added or “fed” into a reactor. In continuous polymerization operation, each feed independently may be continuous or intermittent. The quantities or “feeds” may be measured, e.g., by metering, to control amounts and relative amounts of the various reactants and reagents in the reactor at any given time.

Feed line. A pipe or conduit structure for transporting a feed.

Hydrophobic fumed silica. A hydrophobic fumed silica is a product of pre-treating a hydrophilic fumed silica (untreated) with a silicon-based hydrophobing agent selected from trimethylsilyl chloride, dimethyldichlorosilane, a polydimethylsiloxane fluid, hexamethyldisilazane, an octyltrialkoxysilane (e.g., octyltrimethoxysilane), and a combination of any two or more thereof; alternatively dimethyldichlorosilane. Examples of the hydrophobic fumed silica are CAB-O-SIL hydrophobic fumed silicas available from Cabot Corporation, Alpharetta Georgia, USA. When the hydrophobing agent is dimethyldichlorosilane, an example of a hydrophobic fumed silica is CAB-O-SIL TS610 from Cabot Corporation.

Inert. Generally, not (appreciably) reactive or not (appreciably) interfering therewith in the inventive polymerization reaction. The term “inert” as applied to the purge gas or ethylene feed means a molecular oxygen (O₂) content from 0 to less than 5 parts per million based on total parts by weight of the purge gas or ethylene feed.

Metallocene catalyst. Homogeneous or heterogeneous material that contains a cyclopentadienyl ligand-metal complex and enhances olefin polymerization reaction rates. Substantially single site or dual site. Each metal is a transition metal Ti, Zr, or Hf. Each cyclopentadienyl ligand independently is an unsubstituted cyclopentadienyl group or a hydrocarbyl-substituted cyclopentadienyl group. The metallocene catalyst may have two cyclopentadienyl ligands, and at least one, alternatively both cyclopentenyl ligands independently is a hydrocarbyl-substituted cyclopentadienyl group. Each hydrocarbyl-substituted cyclopentadienyl group may independently have 1, 2, 3, 4, or 5 hydrocarbyl substituents. Each hydrocarbyl substituent may independently be a (C₁-C₄)alkyl. Two or more substituents may be bonded together to form a divalent substituent, which with carbon atoms of the cyclopentadienyl group may form a ring.

Single-site catalyst. An organic ligand-metal complex useful for enhancing rates of polymerization of olefin monomers and having at most two discreet binding sites at the metal available for coordination to an olefin monomer molecule prior to insertion on a propagating polymer chain.

Single-site non-metallocene catalyst. A substantially single-site or dual site, homogeneous or heterogeneous material that is free of an unsubstituted or substituted cyclopentadienyl ligand, but instead has one or more functional ligands such as bisphenyl phenol or carboxamide-containing ligands.

Ziegler-Natta catalysts. Heterogeneous materials that enhance olefin polymerization reaction rates and are prepared by contacting inorganic titanium compounds, such as titanium halides supported on a magnesium chloride support, with an activator.

Any compound, composition, formulation, mixture, or product herein may be free of any one of the chemical elements selected from the group consisting of: H, Li, Be, B, C, N, O, F, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, Hf, Ta, W, Re, Os, Ir, Pt, Au, Hg, TI, Pb, Bi, lanthanoids, and actinoids; with the proviso that any required chemical elements (e.g., C and H required by a polyolefin; or C, H, and O required by an alcohol) are not excluded.

Alternatively precedes a distinct embodiment. ASTM means the standards organization, ASTM International, West Conshohocken, Pennsylvania, USA. Any comparative example is used for illustration purposes only and shall not be prior art. Free of or lacks means a complete absence of; alternatively not detectable. ISO is International Organization for Standardization, Chemin de Blandonnet 8, CP 401-1214 Vernier, Geneva, Switzerland. IUPAC is International Union of Pure and Applied Chemistry (IUPAC Secretariat, Research Triangle Park, North Carolina, USA). May confers a permitted choice, not an imperative. Operative means functionally capable or effective. Optional(ly) means is absent (or excluded), alternatively is present (or included). PAS is Publicly Available Specification, Deutsches Institut for Normunng e.V. (DIN, German Institute for Standardization) Properties may be measured using standard test methods and conditions. Ranges include endpoints, subranges, and whole and/or fractional values subsumed therein, except a range of integers does not include fractional values. Room temperature: 23° C.±1° C.

Terms used herein have their IUPAC meanings unless defined otherwise. For example, see Compendium of Chemical Terminology. Gold Book, version 2.3.3, Feb. 24, 2014.

If a discrepancy arises between a claimed range for M_{z} and/or a claimed range for M_{w} and a claimed range for M_{z}/M_{w} ratio, the claimed range for M_{z}/M_{w} ratio controls. If a discrepancy arises between a claimed range for M_{w} and/or a claimed range for Mₙ and a claimed range for M_{w}/Mₙ ratio, the claimed range for M_{w}/Mₙ ratio controls.

Charpy Impact Strength Test Method: the Charpy impact strength testing is done at −40° C. according to ISO 179, Plastics—Determination of Charpy Impact Properties. 80 millimeters (mm)×10 mm×4 mm (L×W×T) specimens that are cut and machined from a 4 mm compression molded plaque that has been cooled at 5° C./minute. The specimens are notched on their long sides in the thickness direction to a depth of 2 mm using a notcher device with a 22.5 degree half-angle and a 0.25 radius curvature at its tip. Specimens are cooled in a cold box for 1 hour then removed and tested in less than 5 seconds. The impact tester meets the specification described in ISO 179. The test is typically performed over a range of temperatures spanning about 0° C., −15° C., −20° C., and −40° C. For the present method, the results reported are those for −40° C. temperature. Results are reported in units of kilojoules per square meter (kJ/m²).

Compression Molded Plaque Preparation Method: follow ASTM D4703-16, Annex A-1, Procedure C. Prepare test samples from a compression molded plaque. Place a piece of 5 mils thick polyethylene terephthalate (PET, Mylar) release sheet on a back plate and place a template or mold on top of the back plate. Place in the mold enough resin to fill the mold plus about 10% extra amount. Place a second piece of 5 mils thick PET (Mylar) release sheet over the resin and mold. Place a second back plate on top of the Mylar. Put the resulting ensemble into a compression molding press at 190° C. Press for 6 minutes at 190° C. and at low, contact pressure. After 6 minutes, increase to high pressure and hold for 4 minutes. Then, cool the platens at 15° C.+/−2° C. per minute until the temperature is approximately 40° C. Remove the compression-molded plaque, and allow to cool to room temperature. Stamp a 25 mm disk out of the cooled compression-molded plaque. The thickness of this disk is approximately 3.0 mm.

Density is measured according to ASTM D792-13, Standard Test Methods for Density and Specific Gravity (Relative Density) of Plastics by Displacement, Method B (for testing solid plastics in liquids other than water, e.g., in liquid 2-propanol). Report results in units of grams per cubic centimeter (g/cm³).

Environmental Stress-Cracking Resistance (ESCR) Test Method: ESCR measurements are conducted according to ASTM D1693-15, Standard Test Method for Environmental Stress-Cracking of Ethylene Plastics, Method B and ESCR (10% Igepal, F50) is the number of hours to failure of a bent, notched, compression-molded test specimen that is immersed in a solution of 10 weight percent Igepal in water at a temperature of 50° C.

For a more precise indication of stress-cracking resistance than that characterized by the above ESCR measured according to ASTM D1693-15, use instead notched constant ligament stress (nCLS) test method below.

Notched Constant Ligament Stress (nCLS) Test Method: Notched Constant Ligament Stress (nCLS) values at 600 psi actual pressure are based on ASTM F2136. The nCLS values were used as a more precise indication of performance than the Environmental Stress Crack Resistance (ESCR) based on ASTM D1693-15.

Gel Permeation Chromatography (GPC) Test Method 1 (conventional GPC or “GPC_{conv}”): for measuring molecular weights using a concentration-based detector. Use a PolymerChar GPC-IR (Valencia, Spain) high temperature GPC chromatograph equipped with an internal IR5 infra-red detector (IR5, measurement channel). Set temperatures of the autosampler oven compartment at 160° C. and column compartment at 150° C. Use a column set of four Agilent “Mixed A” 30 cm 20-micron linear mixed-bed columns; solvent is 1,2,4 trichlorobenzene (TCB) that contains 200 ppm of butylated hydroxytoluene (BHT) sparged with nitrogen. Injection volume is 200 microliters. Set flow rate to 1.0 milliliter/minute. Calibrate the column set with 21 narrow molecular weight distribution polystyrene (PS) standards (Agilent Technologies) with molecular weights ranging from 580 to 8,400,000. The PS standards were arranged in six “cocktail” mixtures with approximately a decade of separation between individual molecular weights in each vial. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. Convert the PS standard peak molecular weights (“MPS”) to polyethylene molecular weights (“MPE”) using the method described in Williams and Ward, J. Polym. Sci., Polym. Let., 6, 621 (1968) and equation 1: (M_{polyethylene}=A×(M_{polystyrene})^{B} (EQ1), wherein M_{polyethylene} is molecular weight of polyethylene, M_{polystyrene} is molecular weight of polystyrene, A=0.4315, x indicates multiplication, and B=1.0. Dissolve samples at 2 mg/mL in TCB solvent at 160° C. for 2 hours under low-speed shaking. Generate a baseline-subtracted infra-red (IR) chromatogram at each equally-spaced data collection point (i), and obtain polyethylene equivalent molecular weight from a narrow standard calibration curve for each point (i) from EQ1.

The total plate count of the GPC column set was performed with decane without further dilution. The plate count (Equation 2) and symmetry (Equation 3) were measured on a 200 microliter injection according to the following equations.

$$Plate Count = 5.54 * {( \frac{( R {V}_{Peak Max}}{Peak Width at \frac{1}{2} height} )}^{2} . \qquad ( EQ2 )$$

where RV is the retention volume in milliliters, the peak width is in milliliters, the peak max is the maximum height of the peak, and ½ height is ½ height of the peak maximum.

$$Symmetry = \frac{( Rear Peak R {V}_{one tenth height} - R {V}_{Peak Max} )}{( R {V}_{Peak Max} - Front Peak R {V}_{one tenth height} )} . \qquad Equation 3$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Calculate number-average molecular weight (Mₙ or Mₙ_{^{(GPC)}}), weight-average molecular weight (M_{w} or M_{w}_{^{(GPC)}}), and z-average molecular weight (M_{z} or M_{z}_{^{(GPC)}}) based on GPC results using the internal IR5 detector (measurement channel) with PolymerChar GPCOne™ software and equations 4 to 6, respectively, the baseline-subtracted IR chromatogram at each equally-spaced data collection point (i), and the polyethylene equivalent molecular weight obtained from the narrow standard calibration curve for the point (i) from Equation 1.

$$Equation 4$$

$${Mn}_{( GPC )} = \frac{{\sum }^{i} {IR}_{i}}{{\sum }^{i} ( {IR}_{i} / {M}_{{polyethylene}_{i}} )} . \qquad ( EQ4 )$$

$$Equation 5$$

$${Mw}_{( GPC )} = \frac{{\sum }^{i} ( {IR}_{i} * {M}_{{polyethylene}_{i}} )}{{\sum }^{i} {IR}_{i}} . \qquad ( EQ5 )$$

$$Equation 6$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . \qquad ( EQ6 )$$

Monitor effective flow rate over time using decane as a nominal flow rate marker during sample runs. Look for deviations from the nominal decane flow rate obtained during narrow standards calibration runs. If necessary, adjust the effective flow rate of decane so as to stay within ±2%, alternatively ±1%, of the nominal flow rate of decane as calculated according to equation 7: Flow rate(effective)=Flow rate(nominal)*(RV_{(FM Calculated)}/RV_{(FM Sample)} (EQ7), wherein Flow rate(effective) is the effective flow rate of decane, Flowrate(nominal) is the nominal flow rate of decane, RV_{(FM Calibrated)} is retention volume of flow rate marker decane calculated for column calibration run using narrow standards, RV_{(FM Sample)} is retention volume of flow rate marker decane calculated from sample run, * indicates mathematical multiplication, and/indicates mathematical division. Discard any molecular weight data from a sample run with a decane flow rate deviation more than ±2%, alternatively ±1%.

Gel Permeation Chromatography (GPC) Test Method 2 (absolute GPC or “GPC_{abs}”): for measuring absolute molecular weight measurements. Use a PolymerChar GPC-IR high temperature GPC chromatograph equipped with the internal IR5 infra-red detector (IR5), wherein the IR5 detector is coupled to a Precision Detectors (Now Agilent Technologies) 2-angle laser light scattering (LS) detector Model 2040. For all Light scattering measurements, the 15 degree angle is used for measurement purposes.

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chapter 12, (1992)) (Balke, Thitiratsakul, Lew, Cheung, Mourey, Chromatography Polym. Chapter 13, (1992)), optimizing triple detector log (MW and IV) results from a broad homopolymer polyethylene standard (Mw/Mn>3) to the narrow standard column calibration results from the narrow standards calibration curve using PolymerChar GPCOne™ Software.

The absolute molecular weight data are obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

Absolute weight-average molecular weight (M_{w}_{^{(Abs)}}) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™).

Absolute number-average molecular weight (Mₙ_{^{(Abs)}}) and absolute z-average molecular weight (M_{z}_{^{(Abs)}}) are calculated according to equations 8-9 as follows:

$${Mn}_{( Abs )} = \frac{{\sum }^{i} {IR}_{i}}{{\sum }^{i} ( {IR}_{i} / {M}_{{Absolute}_{i}} )} . \qquad ( EQ 8 )$$

$${Mz}_{( Abs )} = \frac{{\sum }^{i} ( {IR}_{i} * {M}_{{Absolute}_{i}}^{2} )}{{\sum }^{i} ( {IR}_{i} * {M}_{{Absolute}_{i}} )} . \qquad ( EQ 9 )$$

Deconvoluting Test Method: Fit a GPC chromatogram of a bimodal polyethylene into a high molecular weight (HMW) component fraction and low molecular weight (LMW) component fraction using a Flory Distribution that was broadened with a normal distribution function as follows. For the log M axis, establish 501 equally-spaced Log(M) indices, spaced by 0.01, from Log(M) 2 and Log(M) 7, which range represents molecular weight from 100 to 10,000,000 grams per mole. Log is the logarithm function to the base 10. At any given Log(M), the population of the Flory distribution is in the form of the following equation:

$${dW}_{f} = {( \frac{2}{{M}_{w}} )}^{3} ( \frac{{M}_{w}}{0.868588961964} ) {M}^{2} {e}^{( - 2 m / {M}_{w} )} ,$$

wherein M_{w} is the weight-average molecular weight of the Flory distribution; M is the specific x-axis molecular weight point, (10\hat{ }[Log(M)]); and dW_{f} is a weight fraction distribution of the population of the Flory distribution. Broaden the Flory distribution weight fraction, dW_{f}, at each 0.01 equally-spaced log(M) index according to a normal distribution function, of width expressed in Log(M), σ; and current M index expressed as Log(M), μ.

$${f}_{( LogM , μ , σ )} = \frac{{e}^{\frac{{( LogM - μ )}^{2}}{2 {σ}^{2}}}}{σ \sqrt{2 π}} .$$

Before and after the spreading function has been applied, the area of the distribution (dW_{f}/d Log M) as a function of Log(M) is normalized to 1. Express two weight-fraction distributions, dW_{f-HMW} and dW_{f-LMW}, for the HMW copolymer component fraction and the LMW copolymer component fraction, respectively, with two unique M_{w} target values, M_{w-HMW} and M_{w-LMW}, respectively, and with overall component compositions A_{HMW} and A_{LMW}, respectively. Both distributions were broadened with independent widths, σ (i.e., σ_{HMW}=σ_{LMW}, respectively). The two distributions were summed as follows: dW_{f}=A_{HMW}dW_{fHMW}+A_{LMW}dW_{fLMW}, wherein A_{HMW}+A_{LMW}=1. Interpolate the weight fraction result of the measured (from conventional GPC) GPC molecular weight distribution along the 501 log M indices using a 2^{nd}-order polynomial. Use Microsoft Excel™ 2010 Solver to minimize the sum of squares of residuals for the equally-spaces range of 501 Log M indices between the interpolated chromatographically determined molecular weight distribution and the three broadened Flory distribution components (σ_{HMW} and σ_{LMW}), weighted with their respective component compositions, A_{HMW} and A_{LMW}. The iteration starting values for the components are as follows: Component 1: M_{w}=30,000, σ=0.300, and A=0.500; and Component 2: Mw=250,000, σ=0.300, and A=0.500. The bounds for components σ_{HMW} and σ_{LMW} are constrained such that σ>0.001, yielding an M_{w}/Mₙ of approximately 2.00 and σ<0.500. The composition, A, is constrained between 0.000 and 1.000. The M_{w} is constrained between 2,500 and 2,000,000. Use the “GRG Nonlinear” engine in Excel Solver™ and set precision at 0.00001 and convergence at 0.0001. Obtain the solutions after convergence (in all cases shown, the solution converged within 60 iterations).

High Load Melt Index (HLMI) 121 Test Method: use ASTM D1238-13, Standard Test Method for Melt Flow Rates of Thermoplastics by Extrusion Plastometer, using conditions of 190° C./21.6 kilograms (kg). Report results in units of grams eluted per 10 minutes (g/10 min.).

Melt Index (“I₂”) Test Method: for ethylene-based (co)polymer is measured according to ASTM D1238-13, using conditions of 190° C./2.16 kg, formerly known as “Condition E”.

Melt Index I₅ (“I₅”) Test Method: use ASTM D1238-13, using conditions of 190° C./5.0 kg. Report results in units of grams eluted per 10 minutes (g/10 min.).

Melt Flow Ratio MFR2: (“I₂₁/I₂”) Test Method: calculated by dividing the value from the HLMI I₂₁ Test Method by the value from the Melt Index I₂ Test Method.

Melt Flow Ratio MFR5: (“I₂₁/I₅”) Test Method: calculated by dividing the value from the HLMI I₂₁ Test Method by the value from the Melt Index I₅ Test Method.

Melt Strength Test Method: Carried out Rheotens (Göttfert) melt strength experiments isothermally at 190° C. Produced a melt by a Göttfert Rheotester 2000 capillary rheometer, or Rheograph 25 capillary rheometer, paired with a Rheotens model 71.97, with a flat, 30/2 die at a shear rate of 38.2 s-1. Filled the barrel of the rheometer in less than one minute. Waited 10 minutes to ensure proper melting. Varied take-up speed of the Rheotens wheels with a constant acceleration of 2.4 mm/s². The die used for testing has a diameter of 2 mm, length of 30 mm and entry angle of 180 degrees. Load a test sample in pellet form into capillary barrel and allow it to melt and equilibrate at the testing temperature (190° C.) for 10 minutes to give a molten test sample. Then use the piston inside the barrel to apply a steady force on the molten test sample to achieve an apparent wall shear rate of 38.16 s⁻¹, and extrude the melt through the die with an exit velocity of approximately 9.7 mm/s. Located 100 mm below the die exit, guide the extrudate through wheel pairs (spaced 0.4 mm apart) of the rheometer, which both accelerate at a constant rate of 2.4 mm/s² and measure the extrudate's response to the applied extensional force. Display the test results as plots of force with respect to Rheotens wheel speed using the RtensEvaluations2007 Excel software. For analysis, the force at which fracture occurs in the melt is referred to as the melt strength of the material and the corresponding Rheotens wheel speed at fracture is considered the drawability limit. Monitored tension in the drawn strand over time until the strand broke. Calculated melt strength by averaging the flat range of tension.

Resin Swell t1000 Test Method: Characterized resin swell in terms of extrudate swell. In this approach determined the time required by an extruded polymer strand to travel a pre-determined distance of 23 cm. The more the resin swells, the slower the free end of the strand travels, and the longer it takes to cover the 26 cm distance. Used a 12 mm barrel Göttfert Rheograph equipped with a 10 L/D capillary die for measurements. Carried out measurements at 190° C. at a fixed shear rate of 1000 sec-1. Reported the resin swell as t1000 value in seconds (see or s).

2% Secant Modulus Test Method: measured according to ASTM D882-12, Standard Test Methods for Tensile Properties of Thin Plastic Sheeting. Used 2% secant modulus in cross direction (CD) or machine direction (MD). Report results in megapascals (MPa). 1,000.0 pounds per square inch (psi)=6.8948 MPa.

Zero Shear Viscosity Determination Method: perform small-strain (10%) oscillatory shear measurements on polymer melts at 190° C. using an ARES-G2 Advanced Rheometric Expansion System, from TA Instruments, with parallel-plate geometry to obtain complex viscosity |η*| versus frequency (ω) data. Determine values for the three parameters—zero shear viscosity, ηₒ, characteristic viscous relaxation time, τ_{η}, and the breadth parameter, a, —by curve fitting the obtained data using the following Carreau-Yasuda (CY) Model:

$$\vert η * ( ω ) \vert = \frac{{η}_{∘}}{{[ 1 + {( {τ}_{η} ω )}^{a} ]}^{\frac{( 1 - n )}{a}}} ,$$

wherein |η*(ω)| is magnitude of complex viscosity, ηₒ is zero shear viscosity, τ_{η} is viscous relaxation time, a is the breadth parameter, n is power law index, and w is angular frequency of oscillatory shear. Report zero shear viscosity in kilopascal-seconds (kPa-sec). Obtain parameters for the Carreau-Yasuda model by fitting the model to DMS Frequency sweep data. Conduct all DMS frequency tests on either ARES-G2 or DHR-3 rheometer, TA Instruments, and conduct data analyses using TA Instruments' TRIOS software. To prepare for the DMS frequency test, place a test sample into a 1.5 inch diameter chase of thickness 3.10 mm and compression mold the sample at a pressure of 25,000 lbs for 6.5 minutes at 190° C. with a Carver Hydraulic Press (Model #4095.4NE2003). After cooling to room temperature, extract the compression molded sample for rheological testing. Conduct the DMS (dynamic mechanical spectroscopy) frequency sweeps using 25 mm parallel plates at frequencies ranging from 0.1 radian per second (rad/s) to 100 rad/s. Use a test gap separating the plates of 2 mm and a strain that satisfies linear viscoelastic conditions, typically 10% strain. Conduct each test under isothermal conditions and nitrogen atmosphere at 190° C. Prior to initiating the DMS test, allow the rheometer oven to equilibrate at the desired testing temperature for at least 30 minutes. After the testing temperature has equilibrated, load the compression molded sample into the rheometer, and gradually reduce the gap between the plates to a gap of 2.8 mm, and trim excess sample. Allow the trimmed sample to equilibrate for 2.5 minutes, then reduce the gap between the parallel plates to final test gap of 2 mm. Trim the sample again to ensure that no bulge is present, and begin the test. During the test, measure shear elastic modulus (G′), viscous modulus (G″) and complex viscosity. Fit the Carreau-Yasuda model, shown below, to the complex viscosity measurement.

### EXAMPLES

Bis(2-(pentamethylphenylamido)ethyl)amine zirconium dibenzyl is the compound of formula (II) wherein M is Zr and each R is benzyl (“Bn”). It may be made by procedures described in the art or obtained from Univation Technologies, LLC, Houston, Texas, USA, a wholly-owned entity of The Dow Chemical Company, Midland, Michigan, USA. Representative Group 15-containing metal compounds, including bis(2-(pentamethylphenylamido)ethyl)amine zirconium dibenzyl, and preparation thereof can be as discussed and described in U.S. Pat. Nos. 5,318,935; 5,889,128; 6,333,389; 6,271,325; 6,689,847; and 9,981,371; and WO Publications WO 99/01460; WO 98/46651: WO 2009/064404; WO 2009/064452; and WO 2009/064482.

Antioxidant: 1. Pentaerythritol tetrakis(3-(3,5-di(1′,1′-dimethylethyl)-4-hydroxyphenyl)propionate); obtained as IRGANOX 1010 from BASF. May be added to polyethylene resin in post-reactor processing of the resin to inhibit oxidative degradation of the resin composition.

Antioxidant 2. Tris(2,4-di(1′,1′-dimethylethyl)-phenyl)phosphite. Obtained as IRGAFOS 168 from BASF. May be added to polyethylene resin in post-reactor processing of the resin to inhibit oxidative degradation of the resin composition.

Ultraviolet (UV) light stabilizer 1 (“UV Stabilizer 1”): Poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]), obtained as Chimassorb 944 from BASF. Stabilizes copolymer against harmful effects of UV light. May be added to polyethylene resin in post-reactor processing of the resin to inhibit UV light-caused degradation of the resin composition.

CA-300: a continuity additive available from Univation Technologies, LLC. Added to gas phase polymerization reactor to decrease static buildup.

1-hexene Comonomer: H₂C═C(H)(CH₂)₃CH₃. Comonomer co-polymerized with ethylene in the gas phase polymerization reactor.

Ethylene (“C₂”): CH₂═CH₂. Monomer polymerized in the gas phase polymerization reactor. When copolymerized with 1-hexene, makes ethylene/1-hexene copolymer.

ICA: a mixture consisting essentially of at least 95%, alternatively at least 98% of 2-methylbutane (isopentane) and minor constituents that at least include pentane (CH₃(CH₂)₃CH₃). May be added to the gas phase polymerization reactor to enable condensing mode operation thereof.

Molecular hydrogen gas: H₂. May be added to the gas phase polymerization reactor to alter molecular weight of the polyethylene produced therein.

Mineral oil: Sonneborn HYDROBRITE 380 PO White. May be used as a carrier liquid for feeding catalyst into a gas phase polymerization reactor.

10% Igepal means a 10 wt % solution of Igepal CO-630 in water, wherein Igepal CO-630 is an ethoxylated branched-nonylphenol of structural formula 4-(branched-C₉H₁₉)-phenyl-[OCH₂CH₂]ₙ—OH, wherein subscript n is a number such that the branched ethoxylated nonylphenol has a number-average molecular weight of about 619 grams/mole. Used in ESCR test methods.

Preparation 1: synthesis of 3,6-dimethyl-1H-indene, of the formula

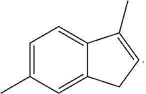

In a glove box, a 250-mL two-neck container fitted with a thermometer (side neck) and a solids addition funnel, was charged with tetrahydrofuran (25 mL) and methylmagnesium bromide (2 equivalents, 18.24 mL, 54.72 mmol). The contents of the container were cooled in a freezer set at −35° C. for 40 minutes; when removed from the freezer, the contents of the container were measured to be −12° C. While stirring, indanone [5-Methyl-2,3-dihydro-1H-inden-1-one (catalog #HC-2282)] (1 equivalent, 4.000 g, 27.36 mmol) was added to the container as a solid in small portions and the temperature increased due to exothermic reaction; additions were controlled to keep the temperature at or below room temperature. Once the addition was complete, the funnel was removed, and the container was sealed (SUBA). The sealed container was moved to a fume hood (with the contents already at room temperature) and put under a nitrogen purge, then stirred for 3 hours. The nitrogen purge was removed, diethyl ether (25 mL) was added to the container to replace evaporated solvent, and then the reaction was cooled using an acetone/ice bath. A HCl (15% volume) solution (9 equivalents, 50.67 mL, 246.3 mmol) was added to the contents of the container very slowly using an addition funnel, the temperature was maintained below 10° C. Then, the contents of the container were warmed up slowly for approximately 12 hours (with the bath in place). Then, the contents of the container were transferred to a separatory funnel and the phases were isolated. The aqueous phase was washed with diethyl ether (3 times 25 mL). The combined organic phases were then washed with sodium bicarbonate (50 mL, saturated aqueous solution), water (50 mL), and brine (50 mL). The organic phase was dried over magnesium sulfate, filtered and the solvent removed by rotary evaporator. The resulting dark oil, confirmed as product by NMR, was dissolved in pentane (25 mL), then filtered through a short silica plug (pre-wetted with pentane) that was capped with sodium sulfate. Additional pentane (25-35 mL) was used to flush the plug, then were combined with the first. The solution was dried by rotary evaporator resulting in 2.87 g (74% yield) of 3,6-dimethyl-1H-indene that was confirmed as product by NMR. ¹H NMR (C₆D₆): δ 7.18 (d, 1H), 7.09 (s, 1H), 7.08 (d, 1H), 5.93 (m, 1H), 3.07 (m, 2H), 2.27 (s, 3H), 2.01 (q, 3H).

Preparation 2: synthesis of (cyclopentadienyl)(1,5-dimethylindenyl)zirconium dimethyl, which is a compound of formula (I) wherein R is H and each X is methyl. In a glovebox under an anhydrous inert gas atmosphere (anhydrous nitrogen or argon gas), 3,6-dimethyl-1H-indene (1.000 g, 6.94 moles) in dimethoxyethane (10 mL) was added to a 120 mL (4-ounce (oz)) container, which was then capped, and the contents of the container were chilled to −35° C. n-butyllithium (1.6M hexanes, 4.3 mL, 0.0069 mole) was added to the container and the contents were stirred for approximately 3 hours while heat was removed to maintain the contents of the container near −35° C. Reaction progress was monitored by dissolving a small aliquot in d8-THF for ¹H NMR analysis; when the reaction was complete, solid cyclopentadienyl zirconium trichloride (CpZrCl₃) (1.821 g) was added in portions to the contents of the container while stirring. Reaction progress was monitored by dissolving a small aliquot in d8-THF for ¹H NMR analysis; the reaction was complete after approximately 3 hours and the contents of the container were stirred for approximately 12 more hours. Then, methylmagnesium bromide (3.0M in ether, 4.6 mL) was added to the contents of the container, after the addition the contents of the container were stirred for approximately 12 hours. Then, solvent was removed in vacuo and the product was extracted into hexane (40 mL) and filtered through diatomaceous earth, washed with additional hexane (30 mL) and then dried in vacuo to provide the cyclopentadienyl(1,5-dimethylindenyl) zirconium dimethyl. (Cyclopentadienyl)(1,5-dimethylindenyl)zirconium dimethyl was confirmed by proton nuclear magnetic resonance spectroscopy (¹H NMR) analysis. ¹H NMR (C₆D₆): δ 7.26 (d, 1H), 6.92 (d, 1H), 6.83 (dd, 1H), 5.69 (d, 1H), 5.65 (m, 1H), 5.64 (s, 5H), 2.18 (s, 3H), 2.16 (s, 3H), −0.34 (s, 3H), −0.62 (s, 3H).

Due to the rules of IUPAC nomenclature it is believed that the dimethyl numbering in the molecule 3,6-dimethyl-1H-indene becomes, after deprotonation thereof, becomes in the conjugate anion 1,5-dimethylindenyl.

Preparation 3: Preparation of Bimodal Catalyst System 1 (AFS-BMCS1). Slurry 70.3 parts by weight of treated fumed silica (CABOSIL TS-610) in 1000 parts by weight of toluene, followed by adding 171 parts by weight of a 30 wt % solution of methylaluminoxane (MAO) in toluene, 3.54 parts by weight of the bis(2-(pentamethylphenylamido)ethyl)amine zirconium dibenzyl and 0.229 parts by weight of cyclopentadienyl(1,5-dimethylindenyl) zirconium dimethyl of Preparation 2 to give a mixture. Using a spray dryer set at 160° C. and with an outlet temperature at 70° to 80° C., introduce the mixture into an atomizing device of the spray dryer to produce droplets of the mixture, which are then contacted with a hot nitrogen gas stream to evaporate the liquid from the mixture to give a powder. Separate the powder from the gas mixture in a cyclone separator and discharge the separated powder into a container to give the Bimodal Catalyst System 1 (“BMCS1”) as a fine powder. Slurry the resultant powder form of BMCS1 to give an activator formulation slurry form of BMCS1 (“AFS-BMCS1”) of 22 wt % solids in 10 wt % isoparaffin fluid and 68 wt % mineral oil.

Preparation 4: preparation of Trim Catalyst Solution 1 (“TCS1”) comprising a trim solution of cyclopentadienyl(1,5-dimethylindenyl) zirconium dimethyl in n-hexane and isopentane. Charge (cyclopentadienyl)(1,5-dimethylindenyl)zirconium dimethyl of Preparation 2 and n-hexane into a first cylinder. Charge the resulting solution of (cyclopentadienyl)(1,5-dimethylindenyl)zirconium dimethyl solution in hexane from the first cylinder into a 106 liter (L; 28 gallons) second cylinder. The second cylinder contained 310 grams of 1.07 wt % (cyclopentadienyl)(1,5-dimethylindenyl)zirconium dimethyl. Added 7.98 kg (17.6 pounds) of high purity isopentane to the 106 L cylinder to yield the Trim Catalyst Solution 1 of 0.04 wt % (cyclopentadienyl)(1,5-dimethylindenyl)zirconium dimethyl in n-hexane and isopentane.

Polymerization Procedure. For Inventive Example 1 described below, copolymerized ethylene and 1-hexene using the Activator Formulation Slurry form of Bimodal Catalyst System 1 (AFS-BMCS1) and a controlled relative amount of the Trim Catalyst Solution 1 (TCS1) in a fluidized bed-gas phase polymerization (FB-GPP) reactor having a distribution grid to make an embodiment of the bimodal poly(ethylene-co-1-alkene) copolymer that is a bimodal poly(ethylene-co-1-hexene) copolymer. The FB-GPP reactor had a 0.35 meter (m) internal diameter and 2.3 m bed height and a fluidized bed composed of polymer granules. Flowed fluidization gas through a recycle gas loop comprising sequentially a recycle gas compressor and a shell-and-tube heat exchanger having a water side and a gas side. The fluidization gas flows through the compressor, then the water side of the shell-and-tube heat exchanger, then into the FB-GPP reactor below the distribution grid. Fluidization gas velocity in the be is about 0.61 meter per second (m/s, 2.0 feet per second). The fluidization gas then exits the FB-GPP reactor through a nozzle in the top of the reactor, and is recirculated continuously through the recycle gas loop. Maintained a constant fluidized bed temperature of 100° C. by continuously adjusting the temperature of the water on the shell side of the shell-and-tube heat exchanger. Introduced feed streams of ethylene, nitrogen, and hydrogen together with the 1-hexene comonomer into the recycle gas line. Operated the FB-GPP reactor at a total pressure of about 2420 kPa gauge, and vented reactor gases to a flare to control the total pressure. Adjusted individual flow rates of ethylene, nitrogen, hydrogen and the 1-hexene to maintain their respective gas composition targets. Set ethylene partial pressure to 1.52 megapascal (MPa, 220 pounds per square inch (psi)), and set the C₆/C₂ molar ratio to 0.0027, and the H₂/C₂ to 0.0005. Maintained isopentane (ICA) concentration at about 5.6 mol %. Average copolymer residence time was 2.6 hours. Measured concentrations of all gasses using an on-line gas chromatograph. Maintained the fluidized bed at constant height by withdrawing a portion of the bed at a rate equal to the rate of formation of particulate product bimodal poly(ethylene-co-1-hexene) copolymer. Product was removed semi-continuously via a series of valves into a fixed volume chamber. A nitrogen purge removed a significant portion of entrained and dissolved hydrocarbons in the fixed volume chamber. After purging, the product was discharged from the fixed volume chamber into a fiber pack for collection. The product was further treated with a small stream of humidified nitrogen to deactivate any trace quantities of residual catalyst and cocatalyst. Set the ratio feed of trim catalyst solution TCS1 to the feed of the bimodal catalyst system AFS-BMCS1 to adjust the HLMI (121) of the produced bimodal poly(ethylene-co-1-hexene) copolymer in the reactor to approximately 6 or 7 g/10 min. Set the catalyst feeds at rates sufficient to maintain a production rate of about 14 to about 18 kg/hour (about 31 to about 40 lbs/hr) of the bimodal poly(ethylene-co-1-hexene) copolymer.

Inventive Example 1 (IE1): synthesized an embodiment of the inventive bimodal poly(ethylene-co-1-hexene) copolymer using the Polymerization Procedure described above, wherein 1-alkene comonomer is 1-hexene, and Activator Formulation Slurry form of Bimodal Catalyst System 1 (AFS-BMCS1) and Trim Catalyst Solution 1 (TCS1). The polymerization conditions and process results are described in Table 1 below and the resin properties are described in Table 2 below.

Comparative Example 1 (CE): Inventive Example 14 (“IE14”) of WO 2020/223191 A1. The copolymer of IE14 of WO 2020/223191 was made using BMC1 prepared as described in Inventive Example 7 of WO 2020/223191 A1. The polymerization conditions and process results are described in Table 1 below and the resin properties of CE1 are reported in Table 2 below.

TABLE 1
Polymerization Conditions of IE1 and CE1.

| Polymerization Conditions | IE1 | CE1 |
|---|---|---|
| Bed Temperature (° C.) | 100 | 105 |
| Reactor Pressure (kPa) | 2420 | 2413 |
| Ethylene (“C₂”) Partial Pressure (kPa) | 1517 | 1520 |
| H₂/C₂ Molar Ratio | 0.0005 | 0.0006 |
| 1-hexene/ethylene (“C₆/C₂”) Molar | 0.0027 | 0.0003 |
| Ratio | | |
| Induced Condensing Agent 1-methylbutane | 5.6 | 11.3 |
| (mol %) | | |
| Superficial Gas Velocity (m/sec) | 0.61 | 0.61 |
| Bimodal Catalyst System | AFS-BMCS1 | BMC1^{a} |
| Trim Catalyst Solution (0.5 wt % TCS1) | TCS1 | TCS1 |
| TCS1/AFS-BMCS1 molar ratio | 0.36 | 0.39 |
| CA-300 Continuity Additive (ppm) | 60 | 39 |
| Catalyst Zr conc. (wt %) | 0.45 | 0.43 |
| Catalyst Al conc. (wt %) | 19.80 | 18.85 |
| Starting seedbed = granular HDPE resin | Preloaded | Preloaded |
| Fluidized Bed Weight (kg) | 42 | 50 |
| Copolymer Production Rate (kg/hour) | 16 | 13 |
| Copolymer Residence Time (hour) | 2.6 | 3.8 |
| Copolymer Fluid Bulk Density, (kg/m³) | 266 | 287 |

^{a}BMC1 used to make CE1 is from WO 2020/223191 A1.

As shown in Table 1, the polymerization catalyst AFS-BMCS1 and TCS1 have been used under controlled gas phase polymerization process conditions to make a bimodal poly(ethylene-co-1-hexene) copolymer having the improved properties shown below in Table 2. Varying the TCS1/AFS-BMCS1 molar ratio can be used to change the copolymer's 121 property. Varying the H₂/C₂ Molar Ratio can be used to change the copolymer's molecular weight.

TABLE 2
Properties of the copolymers of IE1 and CE1 (properties
of the “Copolymer” are of the overall composition
of matter, not an individual HMW or LMW component).

| Overall Formulation Property | IE1 | CE1 |
|---|---|---|
| Copolymer Comonomer | 1-Hexene | 1-hexene |
| Copolymer Density (g/cm³) | 0.947 | 0.955 |
| Copolymer M_{w}/Mₙ (GPC_{(conv)}) | 10.9 | 13.3 |
| Copolymer M_{z}/M_{w} (GPC_{conv}) | 9.6 | 11.1 |
| Copolymer I₂₁ (g/10 min.) | 6.6 | 6.9 |
| Copolymer ESCR (10% Igepal, F50) | >1,000* | 182 |
| (hours) | | |
| Copolymer t1000 Die Swell (seconds) | 10.2 | 9.5 |
| Copolymer M_{w} (g/mol) (GPC_{conv}) | 456,611 | 437,629 |
| Copolymer Mₙ (g/mol) (GPC_{conv}) | 41,993 | 32,912 |
| Copolymer M_{z} (g/mol) (GPC_{conv}) | 4,367,299 | 4,865,000 |
| Copolymer M_{w}/Mₙ (GPC_{abs}) | 9.11 | 11.3 |
| Copolymer M_{z}/M_{w} (GPC_{abs}) | 6.00 | 7.52 |
| Copolymer M_{w} (g/mol) (GPC_{abs}) | 368,623 | 318,832 |
| Copolymer Mₙ (g/mol) (GPC_{abs}) | 40,469 | 28,108 |
| Copolymer M_{z} (g/mol) (GPC_{abs}) | 2,211,095 | 2,396,928 |
| Copolymer Charpy Impact Strength | 42 | 46 |
| (−40° C., KJ/m²) | | |
| Copolymer nCLS (hours) | 477 | 126 |
| Copolymer Melt Strength (cN) | 25 | 17.2 |
| Copolymer 2% Secant Modulus (MPa) | 828 | 1,106 |
| Copolymer Zero-shear viscosity | 1,481 | N/m |
| (kPa-sec) | | |
| Split HMW Component (wt %) | 30.0 | 28.1 |
| Split LMW Component (wt %) | 70.0 | 71.9 |

N/R means not reported.
N/m means not measured.

As shown in Table 2, the inventive bimodal poly(ethylene-co-1-hexene) copolymer has, among other things, a unique balance of properties comprising M_{z}/M_{w} ratio, t1000 die swell, Charpy impact strength, melt strength, and environmental stress cracking resistance (ESCR) performance. The inventive bimodal poly(ethylene-co-1-hexene) copolymer has two or more improved properties selected from the group consisting of: increased ESCR, despite a lower M_{z}/M_{w} ratio compared to that of CE1; good processability (comparable high load melt, index); increased melt strength; increased t1000 die swell, despite a lower M_{z}/M_{w} ratio compared to that of CE1; and increased Mₙ, despite a lower M_{z} compared to that of CE1. Without being bound by theory, it is believed that this improves IBC performance in terms of increased top load (stiffness), increased toughness, increased impact strength, and/or increased environmental stress crack resistance (ESCR). The bimodal poly(ethylene-co-1-hexene) copolymer has the blow molding processability and polymer melt strength, and a good combination of stiffness, improved toughness, impact strength, and stress crack resistance. This enables manufacturing methods wherein the copolymer is melt-extruded and blow molded into large-part blow molded (LPBM) articles, which are larger, longer, and/or heavier than typical plastic parts. This improved performance enables the copolymer to be used not just for IBCs but also for geomembranes, pipes, and tanks. Nevertheless the copolymer is especially suited for making intermediate bulk containers or “IBCs”.

Inventive Example 2 (IE2): formulation comprising the bimodal poly(ethylene-co-1-hexene) copolymer of IE1, Antioxidant 1, Antioxidant 2, and UV Stabilizer 1. A portion the bimodal poly(ethylene-co-1-hexene) copolymer of IE1 is mixed with 1,000 parts per million weight/weight (ppm) of Antioxidant 1, 1000 ppm Antioxidant 2, and 1,000 ppm UV Stabilizer 1 in a ribbon blender, and then compounded into strand cut pellets using a twin-screw extruder Coperion ZSK-40 to give the formulation of IE2.

Inventive Example 3 (IE3) (prophetic): a process of making an intermediate bulk container comprising the bimodal poly(ethylene-co-1-hexene) copolymer of IE1 or the formulation of IE2 and the intermediate bulk container made thereby. An intermediate bulk container (IBC) is fabricated from the bimodal poly(ethylene-co-1-hexene) copolymer of IE1 or the formulation of IE2 on a blow molding machine containing an accumulator head, an annular die, two blow pins, and two mold halves. When configured together, the mold halves define a mold cavity for shaping the IBC. The two blow pins are located between the mold halves. Examples of such blow molding machines are Kautex KBS series, Bekum BA-330, Graham Engineering Hercules series, and Uniloy, Inc. UMA series. An extruder feeds an appropriate-sized “shot” of a melt of the copolymer or formulation into the accumulator head of the blow molding machine, which intermittently extrudes an initial parison through the annular die over the two blow pins between the two mold halves. By appropriately sized, it is meant that the amount of the shot is controlled to match the size of the mold cavity and ultimately make the IBC without defects (e.g., voids or incomplete filling of the mold) and without a large amount of excess copolymer or formulation left over. For fabricating larger IBCs, the extruder may allow the amount of melt to accumulate until the desired size of the shot is reached, whereupon it is fed into the accumulator head of the blow molding machine. The initial parison, a round molten copolymer or formulation, has a wall thickness called the “parison thickness”, and is stretched out within the mold cavity by the blow pins. A gas (e.g., air, nitrogen, or argon) is injected into the mold cavity so as to blow mold the stretched parison into the shape of the intermediate bulk container in the mold cavity. The blow-molded IBC is allowed to cool and removed from the mold. The IBC may be trimmed of any excess material before being used to store or transport bulk chemicals, raw materials, food ingredients, petrochemicals, rainwater, paint, industrial coatings, pharmaceutical compounds, wine, spirits, or waste materials.

1. A bimodal poly(ethylene-co-1-alkene) copolymer comprising from 25.5 weight percent (wt %) to 34.4 wt % of a higher molecular weight poly(ethylene-co-1-alkene) copolymer component (HMW copolymer component) and from 74.5 wt % to 65.6 wt %, respectively, of a lower molecular weight poly(ethylene-co-1-alkene) copolymer component (LMW copolymer component), and wherein the copolymer has each of properties (a) to (h):
(a) a density from 0.942 to 0.949 gram per cubic centimeter (g/cm³), measured according to ASTM D792-13 (Method B, 2-propanol);
(b) a high load melt index (HLMI or I₂₁) from 5.0 to 8.0 grams per 10 minutes (g/10 min.) measured according to ASTM D1238-13 (190° C., 21.6 kg);
(c) a ratio of M_{w}/Mₙ from 8.1 to 10.1, wherein M_{w} is weight-average molecular weight and Mₙ is number-average molecular weight, both measured by Gel Permeation Chromatography (GPC) Test Method 2 (GPC_{(abs)});
(d) a ratio of M_{z}/M_{w} from 5.0 to 7.0, wherein M_{z} is z-average molecular weight and M_{w} is weight-average molecular weight, both measured by GPC Test Method 2 (GPC_{(abs)});
(e) a resin swell t1000 from 9.5 seconds to 10.5 seconds, measured according to Resin Swell t1000 Test Method;
(f) an environmental stress cracking resistance (ESCR) greater than 900 hours, measured according to ASTM D1693-15, Method B (10% Igepal, F50);
(g) a melt strength from 21 to 29 centinewtons (cN), measured at 190° C. by Melt Strength Test Method; and
(h) a zero-shear viscosity (“ηₒ”) from 1,100 to 1,940 kilopascal-seconds (Pa-sec), measured according to Zero Shear Viscosity Determination Method; and
wherein the wt % of the HMW copolymer component and the wt % of the LMW copolymer component are calculated based on the combined weight of these components.

2. The bimodal poly(ethylene-co-1-alkene) copolymer of claim 1, wherein the copolymer has at least one of properties (a1) to (h1):
(a1) the density is from 0.944 to 0.948 g/cm³, alternatively from 0.946 to 0.948 g/cm³;
(b1) the high load melt index (HLMI or I₂₁) is from 5.0 to 7.4 g/10 min., alternatively from 5.7 to 7.0 g/10 min.;
(c1) the ratio of M_{w}/Mₙ (GPC_{(abs)}) is from 8.7 to 9.5, alternatively from 8.9 to 9.3;
(d1) the ratio of M_{z}/M_{w} (GPC_{(abs)}) is from 5.5 to 6.5, alternatively from 5.8 to 6.2;
(e1) the resin swell t1000 is from 9.8 seconds to 10.4 seconds, alternatively from 10.0 seconds to 10.4 seconds;
(f1) the environmental stress cracking resistance (ESCR) is greater than 1000 hours;
(g1) the melt strength is from 23 to 27 cN; and
(h1) the zero shear viscosity is from 1,350 to 1,540 kPa-sec.

3. The bimodal poly(ethylene-co-1-alkene) copolymer of claim 1, wherein the copolymer has at least one of properties (i) to (m):
(i) a weight-average molecular weight (M_{w}) from 325,000 grams per mole (g/mol) to 440,000 g/mol, measured by the GPC Test Method 2 (GPC_{(abs)});
(j) a number-average molecular weight (Mₙ) from 33,000 g/mol to 47,000 g/mol, measured by the GPC Test Method 2 (GPC_{(abs)});
(k) a z-average molecular weight (M_{z}) from 1,600,000 g/mol to 2,900,000 g/mol, measured by the GPC Test Method 2 (GPC_{(abs)});
(l) a Charpy impact strength from 38 to 45 kilojoules per square meter (kJ/m²), measured at −40° C. according to ISO 179; and
(m) a 2% secant modulus from 701 megapascals (MPa) to 930 MPa, measured according to ASTM D882-12.

4. The bimodal poly(ethylene-co-1-alkene) copolymer of claim 3, wherein the copolymer has at least one of properties (i1) to (m1):
(i1) the weight-average molecular weight (M_{w}) (GPC_{(abs)}) is from 330,000 g/mol to 420,000 g/mol, alternatively from 350,000 g/mol to 390,000 g/mol;
(j1) the number-average molecular weight (Mₙ) (GPC_{(abs)}) is from 35,000 g/mol to 45,000 g/mol, alternatively from 38,000 g/mol to 42,000 g/mol;
(k1) the z-average molecular weight (M_{z}) (GPC_{(abs)}) is from 1,900,000 g/mol to 2,700,000 g/mol, alternatively from 2,050,000 g/mol to 2,400,000 g/mol;
(l1) the Charpy impact strength is from 40.0 to 44.0 kJ/m²; and
(m1) the 2% secant modulus is from 740 MPa to 899 MPa.

5. The bimodal poly(ethylene-co-1-alkene) copolymer of claim 4, wherein the bimodal poly(ethylene-co-1-alkene) copolymer has each of properties (a1) to (h1) and at least one, alternatively each of properties (i1) to (m1).

6. The bimodal poly(ethylene-co-1-alkene) copolymer of claim 1 comprising from 27 wt % to 33 wt % of the HMW copolymer component and from 73 wt % to 67 wt %, respectively, of the LMW copolymer component; alternatively from 28 wt % to 32 wt % of the HMW copolymer component and from 72 wt % to 68 wt %, respectively, of the LMW copolymer component.

7. A method of making the bimodal poly(ethylene-co-1-alkene) copolymer of claim 1, the method comprising contacting ethylene and 1-alkene with a bimodal catalyst system and a controlled relative amount of a trim catalyst solution in a single gas phase polymerization (GPP) reactor under effective polymerization conditions to give the bimodal poly(ethylene-co-1-alkene) copolymer; wherein the bimodal catalyst system consists essentially a metallocene catalyst, a single-site non-metallocene catalyst that is a bis((alkyl-substituted phenylamido)ethyl)amine catalyst, a support material, and an activator; wherein the support material is a hydrophobized fumed silica; wherein the metallocene catalyst is an activation reaction product of contacting an activator with a metal-ligand complex of formula (I): (R¹ₓCp)((alkyl)_{y}Indenyl)MX₂ (I), wherein subscript x is 0 or 1; each R¹ independently is methyl or ethyl; subscript y is 1, 2, or 3; each alkyl independently is a (C₁-C₄)alkyl; M is titanium, zirconium, or hafnium; and each X is independently a halide, a (C₁ to C₂₀)alkyl, a (C₇ to C₂₀)aralkyl, a (C₁ to C₆)alkyl-substituted (C₆ to C₁₂)aryl, or a (C₁ to C₆)alkyl-substituted benzyl; wherein the bis((alkyl-substituted phenylamido)ethyl)amine catalyst is an activation reaction product of contacting an activator with a bis((alkyl-substituted phenylamido)ethyl)amine ZrR₂, wherein each R is independently selected from F, Cl, Br, I, benzyl, —CH₂Si(CH₃)₃, a (C₁-C₅)alkyl, and a (C₂-C₅)alkenyl; wherein the trim catalyst solution is an additional amount of the metallocene catalyst and/or the metal-ligand complex of formula (I) dissolved in an alkane (e.g., hexane or mineral oil; and wherein the method controls properties (a) density and (b) high load melt index of the bimodal poly(ethylene-co-1-alkene) copolymer by the controlling the amount of the trim catalyst solution relative to the amount of the bimodal catalyst system in the contacting step.

8. The method of claim 7, wherein the metal-ligand complex of formula (I) is of formula (Ta): 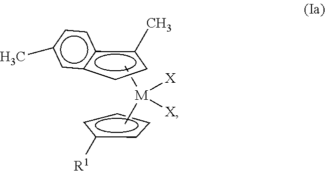
wherein R¹ is H, M is Zr, and each X is as defined therein; and
wherein the bis((alkyl-substituted phenylamido)ethyl)amine ZrR₂ is of formula (II): 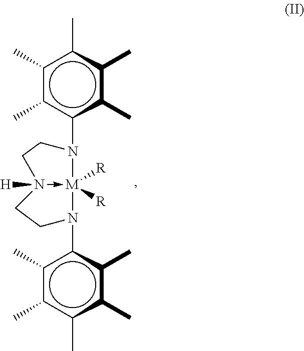
wherein each R is benzyl.

9. A formulation comprising the bimodal poly(ethylene-co-1-alkene) copolymer of claim 1 and at least one additive that is different than the copolymer, wherein the at least one additive comprises an antioxidant.

10. An intermediate bulk container comprising the bimodal poly(ethylene-co-1-alkene) copolymer of claim 1.

11. A method of making the intermediate bulk container of claim 10, the method comprising extruding-melt-blowing the bimodal poly(ethylene-co-1-alkene) copolymer under large-part blow molding conditions so as to make the intermediate bulk container, wherein the extruding-melt-blowing of the bimodal poly(ethylene-co-1-alkene) copolymer comprises conveying a melt of the bimodal poly(ethylene-co-1-alkene) copolymer, optionally containing at least one additive, into a mold cavity; forcing compressed air into the mold, thereby creating a hollow recess in the molded melt mixture; and cooling the resulting molded article to make the intermediate bulk container.

12. The invention of claim 1 wherein the bimodal poly(ethylene-co-1-alkene) copolymer is a bimodal poly(ethylene-co-1-hexene) copolymer.
